(19) United States
(12) Patent Application Publication
(10) Pub. No.: US 2007/0169605 A1
(43) Pub. Date: Jul. 26, 2007

(54) Components having sharp edge made of sintered particulate material

(76) Inventor: David A. Szymanski, St. Mary's, PA (US)

Correspondence Address: PEARNE & GORDON LLP, 1801 EAST 9TH STREET, SUITE 1200, CLEVELAND, OH, 44114-3108, US

(21) Appl. No.: 11/506,312

(22) Filed: Aug. 19, 2006

Related U.S. Application Data
(63) Continuation-in-part of application No. 11/337,294, filed on Jan. 23, 2006.

(51) Int. Cl. B27B 33/14

(52) U.S. Cl. 83/834; 83/830

(57) ABSTRACT

Safety chain and rotatable devices for saws include a plurality of base members on which sharp members are retained. The sharp members include sintered particulate material such as tungsten carbide, which has high particle hardness. The base members are formable from sintered particulate material. The sharp members to be formed by powder metal molding, metal injection molding or investment casting to provide the protrusion and recess with a final net shape. The cutting member is one, two or more pieces, and is permanently bonded to or removably disposed on the base member. Bonding material or fasteners can connect the cutting member to the base or a tip to an insert body; bonding material includes cement, solder, braze and polymer. Safety lobes prevent the teeth from being dislodged. Devices include dado blade, planer blade and bandsaw blade, chain saw, buck saw, rescue saw, automated wood cutting apparatus, circular saw, saw blade, knife, scissors, shears, grass cutter, weed cutter, grass cutting blade and weed cutting blade.

### RELATED APPLICATION

This application is a continuation-in-part of U.S. Ser. No. 11/337,294, filed Jan. 23, 2006, entitled “Safety Chain and Rotational Devices and Replaceable Teeth Therefor,” which is incorporated herein by reference in its entirety.

### FIELD OF THE INVENTION

The present invention relates to the field of carbide tipped devices including saw chain and circular blades.

### BACKGROUND OF THE INVENTION

A variety of devices exist in various applications for cutting or abrading various materials including masonry, concrete, metal, glass, wood and stone. These devices can employ various implements for cutting or abrading including chain and rotary blades.

In the timber industry, wood is cut, for example, using chain saws, timber harvesters and band saws. The particular chain or saw that is used depends on the area and condition of the wood being cut. Normally, steel cutting links having sharp edges are used to cut wood. However, when there is a danger of the chain impacting metal articles in the wood, costly carbide tips can be soldered onto the steel cutting links of the chain. This enables the chain to withstand contact with metal articles in the wood without becoming excessively dull. On the other hand, the soldered carbide tips can become dislodged from the steel cutters upon impact with steel articles in the wood.

The sharp surfaces of all cutting links of saw chain and saw blades undergo expected wear over time. In the case of chain saws, worn chain is sharpened in the field or replaced with new or sharpened chain, leading to costly down time during the cutting operation or hazard to the worker sharpening the cutting links by hand.

Some attempts have been made to construct chains with removable cutting inserts of various designs, typically from steel. These efforts have generally been unsuccessful. Saw chain having removable cutting inserts currently is not used extensively, if at all. U.S. Pat. No. 2,583,243 discloses saw chain including removable teeth wedged into a slot of a head of a link of the chain. U.S. Pat. No. 2,852,048 discloses saw chain with removable teeth having a T-shaped recess that contacts a T-shaped element of a link of the chain. U.S. Pat. No. 3,547,167 discloses a removable cutting sleeve having a recess that receives a stud of a link of the chain.

Cutting links for wood cutting typically are constructed of stamped and machined metal (e.g., steel) and are permanently affixed to other links of the chain. Previously proposed removable cutting inserts were retained on the cutting links using screws or other means. However, so far as the present inventor is aware, such chains do not employ a safety device, apart from fasteners or particular engagement between the cutting inserts and cutting links, for avoiding the dangerous condition of the teeth becoming dislodged during operation of the saw.

Numerous devices include blades with various cutting implements. While some blades employ removable inserts, these do not employ a carbide tip or other tip of suitable hardness that is bonded or fastened to an insert made of sintered particulate material as far as the inventor is aware. Moreover, these devices do not permanently bond to base members spaced around the periphery of the blade, a carbide or other suitable high hardness cutting member, which is one piece or includes a tip. The tip and/or the insert are not made by powder metal molding, metal injection molding or investment casting.

The timber industry and other fields of cutting or abrading materials could benefit from chain and other rotatable devices for saws that include quickly replaceable teeth, yet also are designed with safety features that protect the operator and those in the vicinity from the dangerous condition of whole teeth being thrown from the saw at high speed.

It is known that carbide is harder than steel and resists dulling when in contact with metal objects in the wood being cut. Another advantage is that other material besides wood may be cut by a carbide-tipped saw including metal and concrete. In making carbide tipped steel chain for wood cutting, commercially available steel chain is machined to form a surface on which molded carbide tips may be brazed. This surface is often flat as it is difficult to machine complex seating surfaces in each steel cutting link. The carbide tips are brazed onto the chain one at a time. In addition to the high cost, this process is difficult and inefficient. Carbide tips are difficult to properly orient during brazing and are occasionally dislodged during cutting with a saw that employs the chain. Flying carbide tips from a rapidly moving chain are hazardous to the operator and those nearby. In addition, once a carbide tip has been lost, the entire chain must be returned for brazing another carbide tip onto the chain. Remounting carbide tips is an expensive process. In view of these drawbacks, the amount of carbide tipped chain sold each year is small relative to the total amount of untipped steel saw chain sold.

### DISCLOSURE OF THE INVENTION

The present invention features various embodiments of sharp carbide devices including carbide saw chain and carbide circular blades. The saw chain includes a plurality of links including drive links, cutting links and tie straps, which are pivotally interconnected by rivets. The inventive carbide saw chain includes carbide cutting members bonded to base member portions of the cutting links. Another aspect of the invention features cutting insert bodies removably disposed on the base members and carbide cutting members bonded to the cutting insert bodies.

Suitable materials used for any of the inventive components disclosed herein include tungsten carbide, A2, D2, CPM, S7, high speed steel, ceramics, composites and compositions including ceramic whiskers.

More specifically, in the first embodiment the cutting links include the base member comprised of sintered particulate metal material and the cutting member formed of sintered particulate carbide material. The base member includes holes for receiving the rivets that pivotally connect it to tie straps, a drive link, or other link of the chain. One of the base member and cutting member includes a protrusion and the other of the base member and cutting member includes a recess configured to receive the protrusion. A bond may be formed between the protrusion and recess.

The cutting member can be rigidly connected to the base member using bonding material selected from the group consisting of cement, braze, solder, polymer (e.g., epoxy resin) and combinations thereof. In one aspect, the cutting member and base member are formed by a process that provides them with a near final net shape. Examples of suitable processing include powder metal molding, metal injection molding and investment casting. In particular, the entire cutting member is formed at the final net shape without any sharpening. As an optional step, although it is not necessary, the cutting edge may be ground for further sharpening. The tie straps and drive links are formed of steel. The base member has a body portion extending upwardly to a height of the tie straps along the chain and a seat portion extending above the body portion. The seat on the base may be in the form of a key and the cutting member may include a blind keyway extending from a rear portion of the insert toward a front portion of the insert, or other type of seat surfaces on the base and insert, such as disclosed in U.S. patent application Ser. No. 10/780,323, which is incorporated herein by reference in its entirety. The insert and the base may include a wedge and taper configuration as disclosed in the Ser. No. 10/780,323 application. On the other hand, the key and keyway may be suitably formed without a wedge and taper, as in the case where a safety link is disposed upstream of the cutting link and a safety lobe extends in proximity to the insert, preventing it from becoming dislodged. The cutting insert can have a generally rectangular body having a front surface and a rear surface. A blind keyway is disposed from the rear surface toward the front surface of the body. The front surface includes the recess or protrusion.

In another embodiment of the invention, the cutting links include a base member comprised of sintered particulate metal material. A cutting insert formed of sintered particulate metal material is adapted to be removably disposed on the base member. A cutting tip is formed of sintered particulate carbide material. The base member includes holes for receiving the rivets. One of the cutting insert body and cutting tip includes a protrusion and the other includes a recess configured to receive the protrusion. A bond may be located between the protrusion and recess for rigidly interconnecting the cutting tip and insert body.

Referring to specific features of the second embodiment, a fastener is not needed to prevent the cutting insert from being removed from the base member. One aspect of the invention prevents the cutting insert and bonded cutting tip from being dislodged from the base member using a safety lobe or safety link as disclosed in U.S. patent application Ser. No. 11/337,294, which is incorporated herein by reference in its entirety. The cutting member is a carbide tip. The carbide tip is bonded to the cutting insert by cementing, brazing, soldering or using polymer. The cutting member and cutting insert are formed effective to provide the protrusion and recess with a final net shape. The entire cutting member is formed at the final net shape with a sharp edge and is not machined. An optional grinding step to further sharpen the edge may be carried out but is not necessary. The tie straps and drive links are formed of steel.

### Safety Devices

The following is a disclosure from related U.S. patent application Ser. No. 11/337,294, entitled “Safety Chain and Rotational Devices and Replaceable Teeth Therefor,” (hereinafter referred to as the “Safety Devices Application”), which is useful in the present invention in which the chain or circular blade employs a safety feature for preventing the replaceable insert or tooth from being unintentionally dislodged during operation of the device. The safety saw chain includes a plurality of links each having an upstream end and a downstream end relative to a direction of travel of the chain. Among the components of the chain there is a holding link, a replaceable tooth, the holding link and the replaceable tooth being adapted to removably retain the tooth on the holding link, and a safety lobe extending from one of the links in proximity to the tooth effective to prevent the tooth from being dislodged from the holding link during travel of the chain. In one aspect, the chain includes a safety link that is pivotably connected near its downstream end to the upstream end of the holding link, the safety lobe being integrally formed with and disposed near the downstream end of the safety link. In another aspect the chain includes a safety link that is pivotably connected near its upstream end to the downstream end of the holding link, the safety lobe being integrally formed with and disposed near the upstream end of the safety link. This safety lobe is arcuate and the tooth includes an arcuate recess that is configured and arranged to receive the arcuate safety lobe. The chain can include one or both of the upstream and downstream safety links and these links can be the same or different in design.

In another aspect of this embodiment of the Safety Devices Application, the saw chain includes the holding link which has a seating surface. The replaceable tooth includes a seating surface. The tooth is adapted to be removably retained on the holding link such that the seating surface of the tooth engages the seating surface of the holding link. The tooth is unrestrained by contact with the seating surface of the holding link from movement in the chain travel direction. A safety link comprises a safety lobe extending in proximity to the tooth effective to prevent the tooth from being dislodged from the cutting link during travel of the chain. More specifically, the holding link includes a key member that includes the seating surface of the holding link. The tooth includes a recess configured and arranged to receive the key member, and the recess includes the seating surface of the tooth.

Referring to specific features of the saw chain of the Safety Devices Application, the holding link includes a depth gauge located at its upstream end. Alternatively, the safety link includes a depth gauge located upstream of the tooth. The tooth is connected to the holding link without a fastener (e.g., without a screw). The chain includes alternating right-handed and left-handed teeth. The chain has a central axis along the chain travel direction. The left-handed teeth have cutting surfaces that extend from the central axis outwardly on a left side of the chain and the right-handed teeth have cutting surfaces that extend from the central axis outwardly on a right side of the chain. The saw chain is adapted for use on a saw selected from the group consisting of a chain saw, a timber harvester, a rescue saw, a buck saw and a saw for cutting wood pallets. The tooth includes a sharp cutting surface that can adapted to cut various materials including wood, plastic and metal. The tooth can include a surface adapted for abrasion of material including masonry (e.g., brick), glass, concrete and pavement. The chain includes connector straps that each include a pair of holes. The links each include a pair of holes. Rivets are disposed in aligned holes of the links and connector straps.

A method of safely operating the saw chain according to the Safety Devices Application includes providing the saw chain with the holding link, tooth and the safety link comprising a safety lobe extending in proximity to the tooth. The saw is operated to move the chain at a speed suitable for cutting or abrading. During this operation, movement of the teeth is obstructed with the safety lobes in the direction of chain travel. In a further aspect of the method, the saw is shut off to stop movement of the chain. When the operator determines that a tooth should be replaced, the chain is pivoted so as to move the safety lobe out of a path of the tooth. The tooth is removed from the chain in the chain travel direction. A replacement tooth is inserted on the holding link in a direction opposite to the direction of chain travel.

Another aspect of the Safety Devices Application features a safety rotational device for use in a saw. First and second circular blades are adapted for rotation about a common central axis and disposed in a fixed rotational position relative to each other. A plurality of first holding members are disposed at a periphery of the first blade, each having an upstream end and a downstream end relative to a rotational direction of travel of the circular blades. A plurality of second holding members are disposed at a periphery of the second blade, each having an upstream end and a downstream end relative to a rotational direction of travel of the circular blades. A plurality of first replaceable teeth are adapted to be removably retained on the first holding members. A plurality of second replaceable teeth are adapted to be removably retained on the second holding members. A plurality of first safety lobes are each disposed on the first blade upstream of one of the second holding members in the rotational direction. One of the first safety lobes extends in proximity to one of the second teeth effective to prevent the second tooth from being dislodged from the second holding member during travel of the blades. A plurality of second safety lobes are each disposed on the second blade upstream of one of the first holding members in the rotational direction. One of the second safety lobes extends in proximity to one of the first teeth effective to prevent the first tooth from being dislodged from the first holding member during travel of the blades. A plurality of first depth gauge members are each disposed at a periphery of the first blade upstream of one of the first holding members relative to the rotational direction; and a plurality of second depth gauge members are each disposed at a periphery of the second blade upstream of one of the second holding members relative to the rotational direction. While the depth gauge members may be optional in the case of an automated saw, when cutting with a hand saw or saw under the control of an operator, the depth gauge members may be desirable. More specifically, each of the teeth includes a surface adapted for abrasion of material (e.g., concrete or pavement material). Alternatively, each of the teeth includes a sharp surface adapted for cutting material (e.g., wood, plastic or metal).

Another aspect of the Safety Devices Application features only one safety blade in view of the potential consumer demand for only a single replacement blade. The safety blade comprises a circular blade body adapted for rotation about a central axis, the blade body having an outer peripheral surface. A plurality of holding members are disposed at the peripheral surface each having an upstream end and a downstream end relative to a rotational direction of travel of the blade body. A plurality of replaceable teeth are adapted to be removably retained on the holding members. A plurality of optional depth gauge members are each located upstream of one of the holding members relative to the rotational travel direction and extend a predetermined height from the peripheral surface. A plurality of safety lobes are located between the depth gauge members and the holding members and extend from the peripheral surface to a height less than the height of the depth gauge members. The teeth of the single blade are all either left-handed, all right-handed or alternate left and right handed. Using all left handed teeth or all right handed teeth enables the consumer to replace either the left or right blade in the two blade design.

Another aspect of the Safety Devices Application features a safety rotational device for use in a saw comprising first and second components each of which includes the following. A circular blade is adapted for rotation about a central axis, the blade having an outer peripheral surface. A plurality of holding members are disposed at the peripheral surface each having an upstream end and a downstream end relative to a rotational direction of travel of the blade. A plurality of replaceable teeth are adapted to be removably retained on the holding members. A plurality of depth gauge members each extend a predetermined height from the peripheral surface upstream of one of the holding members relative to the rotational direction. A plurality of safety lobes are located between the holding members and the depth gauge members and each extends a predetermined height from the peripheral surface. The height of the depth gauge members is greater than the height of the safety lobes. The circular blade of the first component is rotationally offset in a fixed position from the circular blade of the second component about the central axis. The safety lobes of the first component are disposed upstream of and in proximity to the teeth of the second component effective to prevent the teeth of the second component from being dislodged from the holding members of the second component. The safety lobes of the second component are disposed upstream of and in proximity to the teeth of the first component effective to prevent the teeth of the first component from being dislodged from the holding members of the first component.

Referring to more specific features of this aspect of the Safety Devices Application, the teeth on the first component are left-handed and the teeth on the second component are right-handed. The holding member includes a seating surface. Each of the teeth includes a seating surface that engages the seating surface of a corresponding one of the holding members. The teeth are unrestrained by the seating surfaces of the holding members from movement in the rotational travel direction. Each of the teeth has a sharp cutting surface adapted to cut material (e.g., wood, metal or plastic). Alternatively, each of the teeth includes a surface adapted for abrasion of material (e.g., masonry, glass pavement or concrete).

A method of safely operating the rotational safety cutting device of the second embodiment of the Safety Devices Application includes providing the first and second components of the device. The circular blade of the first component is positioned so as to be rotationally offset and in a fixed position relative to the circular blade of the second component. The safety lobes of the first component are disposed upstream of and in proximity to the teeth of the second component and the safety lobes of the second component are disposed upstream of and in proximity to the teeth of the first component. The saw is operated to rotate the circular blades. Movement of the teeth of the first component is obstructed with the safety lobes of the second component in the rotational travel direction. Movement of the teeth of the second component is obstructed with the safety lobes of the first component in the rotational travel direction. A further aspect of this method includes shutting off the saw to stop rotation of the components. When it is determined that a tooth should be replaced, the blade of the first component is unfixed from the blade of the second component. The tooth is removed from the holding member in the rotational travel direction. A replacement tooth is inserted on the holding member in a direction opposite to the rotational travel direction. The blade of the first component is fixed to the blade of the second component. The device includes the replacement tooth after this procedure.

### Bonding of Tips

The present invention also features a novel method of bonding cutting members to base or holding members in mass production, which applies to standard steel chain or specialized chain having holding members made of sintered particulate material. In processing standard steel chain, as a first step the steel chain is machined so that the cutting member link includes a protruding first seat portion or recessed second seat portion. The standard cutting edge present on the steel chain is machined away. Next, a cutting member made of one, two or more pieces as described above is fabricated to provide the first seat surface and the second seat surface with a final net shape having a sharp edge. The cutting edge may be optionally ground or machined on the cutting member. Next, the cutting member is rigidly connected to the base or holder using a bonding material selected from cement, braze, solder, polymer or combinations thereof. In the case of an insert having a blind keyway, the blind keyway is oriented generally vertically upwardly and a bead of solder or braze, for example, is deposited on the end of the keyway and key. A plurality of cutting links can have the inserts and holders brazed together in a furnace at suitable temperature. It is believed the solder or braze will flow downward in between the key and keyway, wick into the porosity of the walls forming a very strong bond between these components.

A similar method can be used to bond a tip to a holding member or a cutting member to a holding member when a through hole is formed between front and back surfaces of the tip and an opening is formed in the holder or insert. This too is supported vertically, enabling a plurality of inserts to be bonded to tips at one time in a batch or continuous operation. It is believed the solder or braze will travel downwardly and wick into the porosity of the walls.

The tip can also be rigidly connected to the insert or holding member by forming an unthreaded opening in the tip and a threaded opening in the insert body or holding member, in alignment with each other. Then, a fastener such as a screw in the hole in the tip (which may be countersunk) is threaded into the insert body hole, which rigidly fastens the tip to the insert or holding member.

Another embodiment of the invention features a complex shaped one-piece cutting member formed entirely of sintered particulate material. The shape is the same as shown in FIG. 1 except the teeth are integrally formed with the body of the cutting link, not bonded, not screwed on and not maintained in place by a wedge/taper. The link is formed by a process that enables the component to have a final net shape with a sharp cutting edge after sintering without any grinding. As an optional step the cutting edge can be further sharpened by a grinder, but this is not necessary. This may be made by powder metal molding, metal injection molding and investment casting. The composition of the cutting link is, for example, D2 material, Anchorsteel 4300 by Hoeganaes, or tungsten carbide, which are hard and tough materials. Because the cutting link is formed of hard and tough material, it does not need sharpening after an initial optional sharpening. This enables chains containing the integral sintered particulate cutting links to be disposable. This chain has all of the advantages of the chain disclosed and shown herein, with the added advantage that tips, tooth inserts and cutting members cannot be unintentionally dislodged. While not wanting to be bound by theory, the configuration of the cutter of the cutting link is believed to reduce kickback. The sintered particulate includes a material selected from the group consisting of: metal, ceramic, composites and combinations thereof.

Another embodiment of the invention features the sintered particulate component described herein including surface voids or porosity that capture saw cutting lubricant. This includes but is not limited to: holders, tooth inserts, tips and tipped tooth inserts and the integral one-piece cutting link. Also included are inventive components of: knives, shears and saw blades (e.g., planer blades, band saw blades, dado blades). Even though the components are formed at near theoretical density surface voids remain. During operation, pores of the inventive sintered particulate components capture lubricant, which improves the performance of the components.

The present invention is suitable for a myriad of applications and devices. One application is bandsaw mills. Carbide tips or cutting inserts are added to a bandsaw blade (e.g., having a band thickness of at least 1/16 inch and in particular of about ⅛ inch). First, a metal (e.g., steel) blank of a band saw blade is machined to include a plurality of spaced holders along one edge. This can include the taper and wedge arrangement that is shown and described herein. The holders can include keys and the teeth can be inserts that include keyways. On the other hand, instead of using removable teeth, the inventive bandsaw blade can be tipped with carbide or other suitably hard and tough material known or foreseeable to one of ordinary skill in the art.

The inventive blades (e.g., bandsaw blades) can be formed to have any of the inventive features described in this disclosure. For example, powder metal insert bodies may be used that include a recess at a front end that is adapted to receive protrusions of carbide tips (e.g., on bandsaw blades). The tip has a hole that receives silver solder. The tip protrusion is fitted into the recess of the insert body; the combination is arranged vertically; a small piece of solid solder is positioned in the hole; and the combination is passed through a furnace to melt the solder and distribute it between the protrusion and insert body surface that forms the recess. The solder may travel into an opening in the insert body.

As another example, a cutting member (e.g., shaped like an insert of FIG. 1) with cutting edge includes an untapered keyway and receives an untapered key of the holder. The combination is positioned vertically so that the key is located on top. A small piece of solid silver solder is positioned onto the end of the key and the combination is passed through a furnace. As the furnace heats the solder it runs vertically downward into the keyway and wicks into the porous walls of the key and keyway. This is believed to provide a very strong bond between the cutting member and holder. These methods of soldering or brazing are applicable to bonding any of the components described in this disclosure.

Other applications of the present invention include planers (e.g., wood planning) and dado blades. These may include any of the inventive features of the components described and shown herein. The blades may include tapered or untapered inserts. If untapered, the safety lobes are used (i.e., two blades). One advantage of using the invention on dado and planer blades is rapid change out of tips enabling different widths of cut (e.g., from ⅛ inch to ¼ inch). In a sixth embodiment, a blade includes the inventive component selected from the group consisting of: dado blade, planer blade and bandsaw blade.

In another embodiment, a device includes the inventive component and is selected from the group consisting of: chain saw, buck saw, rescue saw, automated wood cutting apparatus, circular saw, saw blade, fish hook, knife, scissors, shears, grass cutter, weed cutter, grass cutting blade, weed cutting blade and combinations thereof.

In yet another embodiment, the component is in the form of a knife, wherein the first base member is a knife handle and the second member includes a sharp edge on an end of the handle. The second member includes an insert and a tip that are formed of sintered particulate material. The insert is adapted to be removably connected to the first member and one of the tip and insert includes a protrusion and the other of the tip and insert includes a recess adapted to receive the protrusion. The tip includes one of a variety of knife edge sizes and shapes. The tip is comprised of metal having a particle hardness at least as high as that of steel. The first member includes one of a variety of knife handle shapes and sizes, and handle materials.

Referring now to an embodiment featuring a carbide insert on chain without bonding, with a straight key, held on with safety link, the cutting links include a base member comprised of sintered particulate metal material. A one-piece cutting insert is comprised of sintered particulate material including carbide. The cutting insert is adapted to be removably disposed on the base member. The cutting insert includes a sharp cutting edge. The base member includes holes for receiving the rivets. A safety lobe is located in proximity to the cutting insert that prevents dislodging of the cutting insert in a direction of travel of the chain. The safety lobe extends from a link that is located upstream of the cutting link. A depth gauge is located upstream of the cutting insert. The safety lobe is disposed between the depth gauge and the cutting insert at all positions of the chain during a cutting operation.

Referring to another embodiment of the invention, carbide chain that includes the safety links has a metal particulate or steel holder, particulate metal insert and carbide tip. The cutting links include a base member and a cutting insert comprising sintered particulate metal material. The cutting insert is adapted to be removably disposed on the base member or holder. A cutting tip includes a sharp cutting edge and is comprised of sintered particulate carbide material. The base member includes holes for receiving the rivets. One of the cutting insert and tip includes a protrusion and the other includes a recess configured to receive the protrusion. The cutting tip is rigidly connected to the cutting insert. One of the cutting insert and base member includes a first projecting seat surface and the other includes a second recessed seat surface configured to receive the first seat surface. A safety lobe is located in proximity to the cutting insert that prevents dislodging of the cutting insert in a direction of travel of the chain. The safety lobe extends from a location upstream of the cutting link. A depth gauge is located upstream of the cutting insert.

Referring to specific aspects of this embodiment, the base member comprises sintered particulate metal material. The cutting member is separate from the drive link. The base comprises a body extending up to the rivets. The base member is comprised of steel. The first seat surface is formed in the base member above the body. The cutting insert, cutting tip and base member are formed to provide them with a final net shape, except for the cutting edge which is sharpened. The cutting tip has front and rear portions; the cutting edge is disposed near the front portion, and one of the protrusion and recess is disposed near the rear portion of the cutting tip. The cutting insert includes the other of the protrusion and recess disposed near a front portion of the cutting insert.

Referring to another embodiment, a component with high hardness and sharp member formed of sintered particulate material, includes a first base member, a second member comprised of sintered particulate material adapted to be disposed on the base member. The second member includes a sharp edge, the particulate material of said second member having a particle hardness of at least 65 Rockwell C and, in particular at least 70 Rockwell C. The second member has an apparent hardness of at least 40 Rockwell C. One of the second and first base members includes a protruding first seat surface and the other includes a second recessed seat surface configured to receive the first seat surface. The second member is formed to have a final net shape except for the edge which can be sharpened.

Referring to specific features of this embodiment, the protrusion and recess are bonded together with a material selected from the group consisting of cement, solder, braze, polymer and combinations thereof. The high hardness material includes carbide. The base member is comprised of steel. The second member is comprised of ceramic. The first base member is comprised of metal and the second member is comprised of ceramic, including a ceramic-metal bonding material rigidly connecting the second member to the base member.

Another embodiment features a circular blade. The component includes a rigid body in the shape of a circular plate, and a plurality of first members protrude from the plate along a peripheral edge thereof. The second member comprises an insert adapted to be removably disposed on said base and a tip, which are formed of sintered hard particulate material. One of the tip and second insert includes a protrusion and the other of the tip and insert includes a recess adapted to receive the second protrusion. The second member includes a tip formed of carbide and the first seat surface of the base member is steel machined to form the second seat surface. The second member is rigidly connected to the base by a bonding material selected from the group consisting of cement, solder, braze, polymer and combinations thereof.

Another embodiment features a method of manufacturing a component comprised of sintered particulate material comprising the following steps. A die is provided having a cavity therein. A removable core pin is provided in the cavity. A first punch having a recess corresponding to the shape of the core pin, is provided around the core pin in the cavity, at a location short of an end of the core pin. Particulate material is fed into the die around the core pin and onto an internal surface of the first punch. A second punch is provided with a configuration effective to provide a sharp edge to a portion of a part being manufactured. The first and second punches are moved toward each other inside the die cavity by a predetermined distance that is effective to provide the part with suitable density. The part has a first sharp edge formed by the second punch and a blind keyway that is formed by the core pin and first punch. One of the first and second punches is removed from the die and the other punch moves to eject the component from the die. The worn core pin is removed from the die and is replaced with another core pin. The second punch is removed from the die after forming the part and the first punch is raised to eject the part from the die. The parts are sintered in a furnace. The parts are ground to provide a sharp edge.

Many additional features, advantages and a fuller understanding of the invention will be had from the accompanying drawings and the detailed description that follows. It should be understood that the above Disclosure of the Invention describes the invention in broad terms while the following Detailed Description describes the invention more narrowly and presents embodiments that should not be construed as necessary limitations of the broad invention as defined in the claims.

### BRIEF DESCRIPTION OF THE DRAWINGS

FIG. 1 is a perspective view of saw chain constructed in accordance with the present invention;

FIG. 2 is an exploded view of the saw chain of FIG. 1;

FIG. 3 is a side elevational view of the saw chain of FIG. 1;

FIG. 4 is a top plan view of the saw chain as seen along the lines and arrows designated 4-4 in FIG. 3;

FIG. 5 is a vertical cross-sectional view as seen along the lines and arrow designated 5-5 in FIG. 3;

FIG. 6 is a perspective view of one of the holding links and teeth;

FIG. 7 is a side elevational view of the saw chain of FIG. 1 showing how a safety lobe of an upstream link can be rotated out of the path of a tooth for removal and replacement of the tooth;

FIG. 8 is a perspective view showing another aspect of the inventive saw chain wherein the safety links include rakers;

FIG. 9 is an exploded view of the saw chain shown in FIG. 8;

FIG. 10 is a side elevational view of a portion of the saw chain shown in FIG. 8;

FIG. 11 is a perspective view of a portion of saw chain featuring another aspect of the present invention wherein one of the links includes a safety cam member that retains the tooth on the holder;

FIG. 12 is an exploded view of the components of the chain shown in FIG. 11;

FIG. 13 is a side elevational view of the saw chain shown in FIG. 11;

FIG. 14 is a side elevational view of the saw chain shown in FIG. 13 showing how the safety cam and safety lobe are rotated out of the path of the tooth permitting its removal and replacement;

FIG. 15 is a side elevational view of a rotational cutting device constructed in accordance with the present invention;

FIG. 16 is an enlarged view of a portion of the device shown in FIG. 15;

FIG. 17 is a cross-sectional view taken along lines and arrows 17-17 in FIG. 15;

FIG. 18 is an enlarged perspective view of the device shown in FIG. 15;

FIG. 19 is an exploded view of the device shown in FIG. 18;

FIGS. 20-22 illustrate saw chain including teeth adapted for abrasion of material;

FIGS. 23-27 illustrate replaceable teeth adapted for cutting material, used in the saw chain of FIGS. 1-10;

FIGS. 28 and 29 feature another embodiment of the present invention including tipped tooth inserts and optional safety lobes;

FIG. 30 is a side view showing tipped inserts constructed in accordance with the present invention;

FIGS. 31-33 feature inventive tipped inserts in which the tips are rigidly connected to the insert bodies using fasteners;

FIGS. 34-36 feature inventive tipped inserts in which the tips are rigidly connected to the insert bodies using bonding material;

FIG. 37 shows how the tipped insert is kept from being dislodged from the chain using a safety lobe;

FIGS. 38 and 39 show blades including tipped inserts that prevent them from being dislodged via safety lobes on the other blade;

FIGS. 40A-C show an assembled die constructed in accordance with the present invention;

FIGS. 41A and 41B show a part cavity in the die and another cavity for receiving a support member that positions the core pin in a desired location in the cavity;

FIGS. 42A-C show various views of a lower die section;

FIGS. 43A-C show various view of an upper die section;

FIGS. 44A-C feature an upper punch constructed in accordance with the present invention;

FIGS. 45A and 45B feature a lower punch constructed in accordance with the present invention;

FIGS. 46A and 46B feature an upper clamp constructed in accordance with the present invention;

FIGS. 47A and 47B feature a lower clamp constructed in accordance with the present invention;

FIG. 48 shows an integral one-piece cutting link constructed in accordance with the present invention;

FIG. 49 shows a representative blade (e.g., bandsaw) and how tooth inserts are inserted on the blade in accordance with the present invention; and

FIGS. 50 and 51 show scissors and knife that include components constructed in accordance with the present invention.

### DETAILED DESCRIPTION

### I. Safety Devices:

One use of the inventive carbide teeth is in connection with a safety lobe, which is discussed in detail hereafter. However, the present invention is also useful without regard to a safety feature, especially in the case where the carbide cutting member (one piece or with carbide tip) is permanently bonded to the base member or holder, or in an automated cutting operation with suitable shielding of the blade. Therefore, it should be appreciated that, although this description focuses on the inventive safety lobe feature on chain, circular blades and in other applications, the safety lobe feature is optional. The invention resides in the use of a carbide cutting member that is bonded or fastened to the holder or is in the form of an insert that is removably disposed on the base member. The cutting member and insert can each be one piece or two or more pieces.

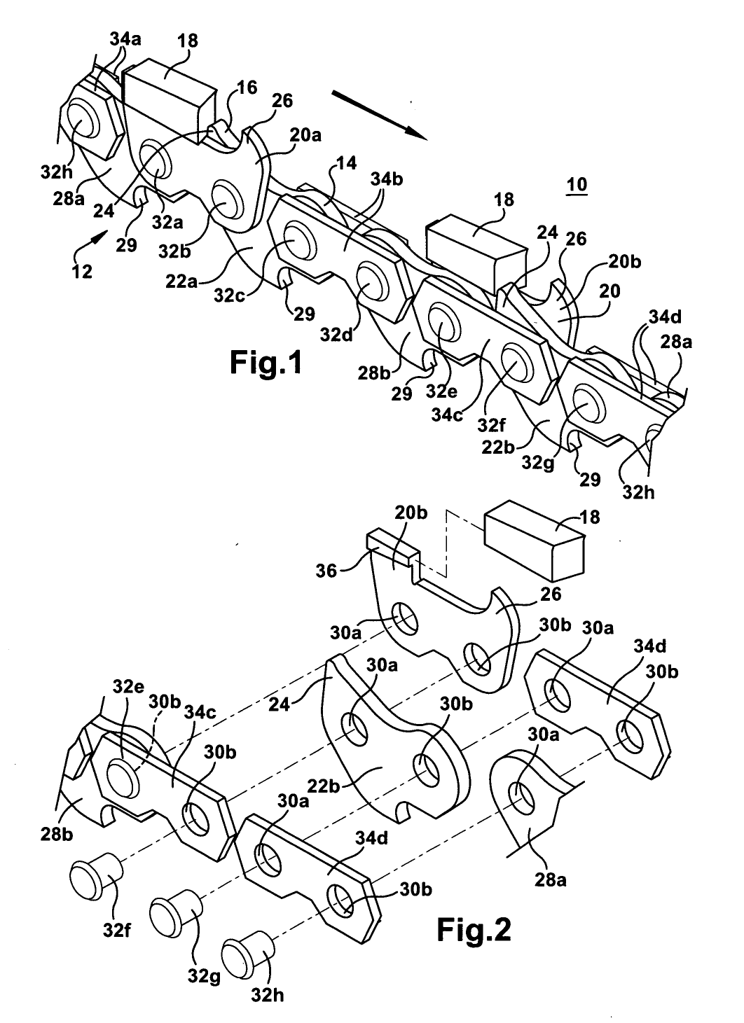

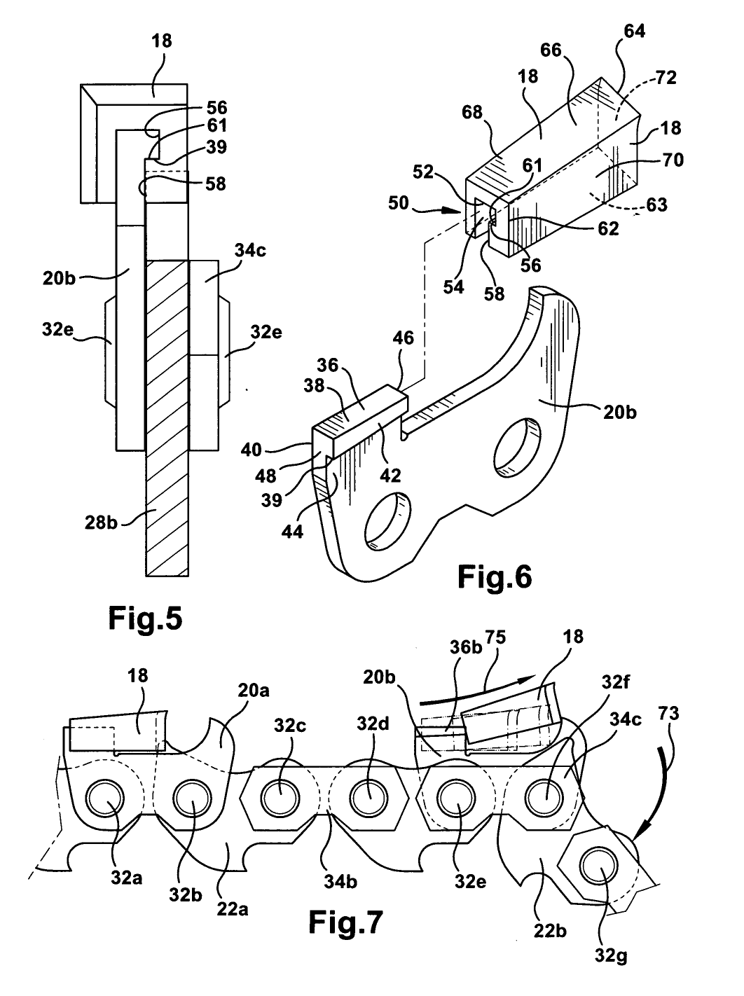

Referring now to FIGS. 1-7 of the drawings, one embodiment is directed to safety saw chain 10 including a plurality of links 12 each having an upstream end 14 and a downstream end 16 relative to a direction of travel of the chain (shown by the arrow) around the bar of a saw in a known manner. A plurality of replaceable teeth 18 are each adapted to be removably retained on one of a plurality of holding links 20. The combination of holding link 20 and replaceable tooth 18 functions as a conventional one-piece cutting link. The chain includes a plurality of safety links 22 each being located upstream of one of the holding links. Each safety link 22 includes a safety lobe 24 extending in proximity to a tooth effective to prevent the tooth from being dislodged from the holding link during travel of the chain. The holding link includes a depth gauge or raker 26 located upstream of the tooth. Other links in the chain of this particular design are contemplated in the invention. For example, drive links or drivers 28 engage the chain saw sprocket and optional sprocket at the end of the guide bar in a conventional manner. Drive links 28 and safety links 22 include surfaces 29 for engaging a sprocket of the saw.

The safety links, holding links, drive links and other links of the chain, each include a pair of rivet holes 30. Connector or tie straps 34 along the chain each include a pair of rivet holes 30. Rivets 32 are disposed in aligned rivet holes of the holding links, safety links, drive links, and other links, and the connector straps, which pivotally connect the links together.

The holding links and safety links are used with other links of the chain in any standard wood-cutting or other chain design (e.g., plastic or metal cutting). For example, in wood cutting the cutting links (i.e., the holding links of the invention) may be used in full compliment, semi-skip (half skip) and full skip chains, referring to the number of tie straps between cutting links. The 2003 website by Manufacturer's Supply Inc., which is incorporated herein by reference in its entirety, describes the chain designs as follows: full compliment chain has a first cutter, tie strap and another cutter (e.g., right cutter, tie strap, left cutter, tie strap, right cutter, etc.); semi-skip chain has alternating one and two tie-straps after cutters (e.g., right cutter, tie strap, left cutter, two ties straps, right cutter, etc.); and full skip chain has two tie straps after cutters (e.g., right cutter, two tie straps, left cutter, two ties straps, right cutter, etc.). The inventive holding link is suitable for all chain pitches (defined as the distance between three consecutive rivets divided by two), including ¼, 0.325, ⅜, ⅜ extended, 0.404, ½ and 0.750 inch pitches. The particular chain shown in FIGS. 1-14 is particularly suitable for use on chain saws. The chain may be used on a variety of other saws as well including, but not limited to a timber harvester, a rescue saw, a buck saw and a saw for cutting wood pallets.

The holding links 20 each include a holding or key member 36 having at least one seating surface. The key member 36 shown in FIGS. 2 and 6 has an inverted-L shape and includes a top surface 38, a long side surface 40, first and second short side surfaces 42, 44, and front and back surfaces 46, 48. Each tooth 18 includes a recess 50 configured and arranged to receive the key member 36. The recess can have an inverted-L shape that corresponds to the inverted-L shaped holding member and includes a top recess surface 52, a long side recess surface 54, first and second short side recess surfaces 56, 58, and a front recess surface 60. Between the short side recess surfaces 56 and 58 is seating surface 61 extending along the length of the tooth. The L-shaped recess is open at a back surface 62 of the tooth and at a bottom tooth surface 63. The recess includes at least one seating surface. Seating surfaces are surfaces of the tooth and holding member that contact each other. It will be appreciated by those of ordinary skill in the art in view of this disclosure that the figures show but one example of a suitable design for the holding member and tooth. The tooth could include a stud and the holding member could include a recess that receives the stud. The key member and tooth recess could include other shapes such as a T-shape. These and many other variations in the design of the teeth and holding members are possible and contemplated to be within the scope of the present invention.

The teeth are inserted onto the chain by pushing each tooth so that the holding member moves into the tooth recess. The holding member front surface 46 may engage the front tooth recess surface 60 (FIG. 3), which prevents the tooth from moving in the direction opposite to the chain travel direction. The seating surfaces of the holding member and tooth engage each other when the tooth is disposed on the holding member during operation of the saw.

A function of the saw chain of the present invention is to enable material to be cut or abraded using teeth that are quickly replaceable and yet safe. In this regard, the teeth advantageously engage the holding members without the need for fasteners (e.g., screws). The teeth can be held in place on the holding members in various ways as would be appreciated by those skilled in the art reading this disclosure. As one example, wedges and tapered surfaces can be formed on the holding members and teeth as disclosed in the U.S. patent application Ser. No. 10/780,323, which is incorporated herein by reference in its entirety. In this case, the wedge and taper inhibit the tooth from moving in a direction opposite to the chain travel direction. The wedge and taper also inhibit movement of the tooth in the chain travel direction. When the teeth are retained on the holding members with the interacting wedge and taper feature, a specialty tool or hammer is used to remove them in the chain travel direction.

The present invention is not limited to the wedge and taper or other design of holding member and teeth. In fact, in one aspect of the invention the holding members do not prevent movement of the teeth in the chain travel direction. Movement of the teeth 18 in the chain travel direction is prevented entirely by the safety lobes 24. This enables very fast replacement of the teeth without the need for a tool (e.g., specialty tool or hammer) which would otherwise be used to remove teeth held in place on the holding members by engagement of tapers and wedges as described in the Ser. No. 10/780,323 patent application.

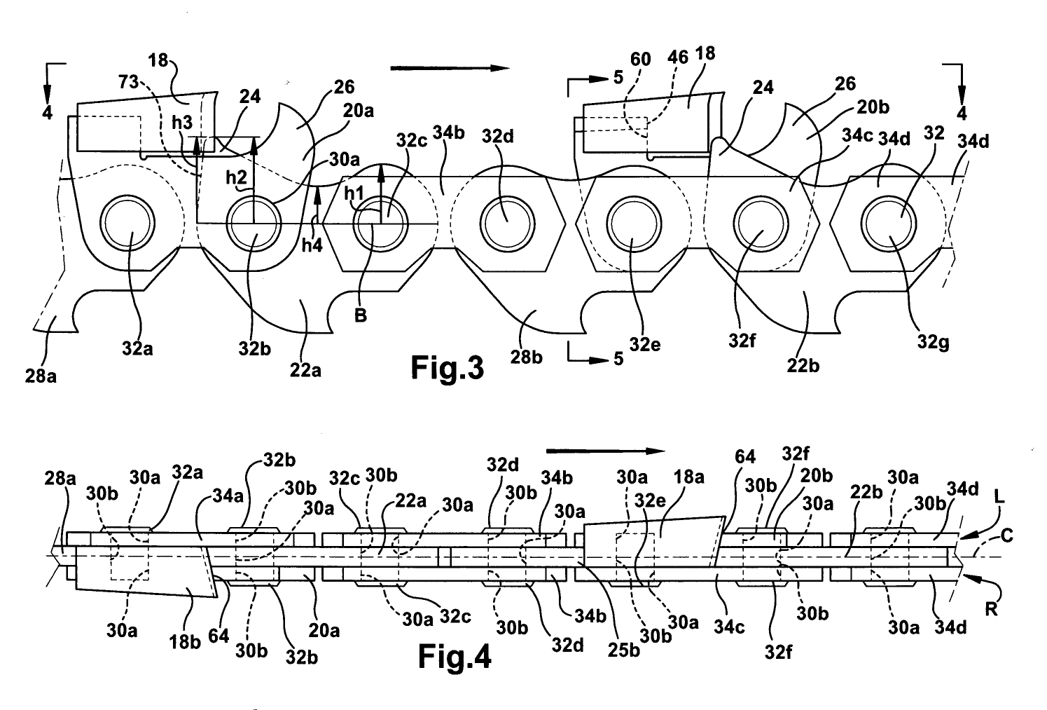

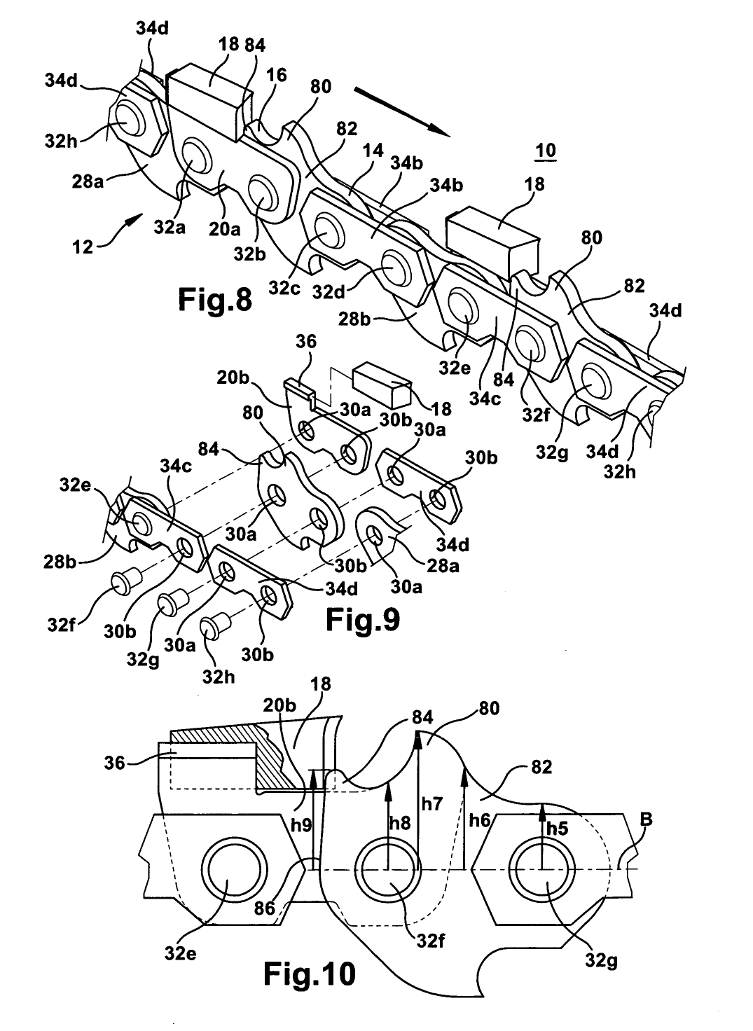

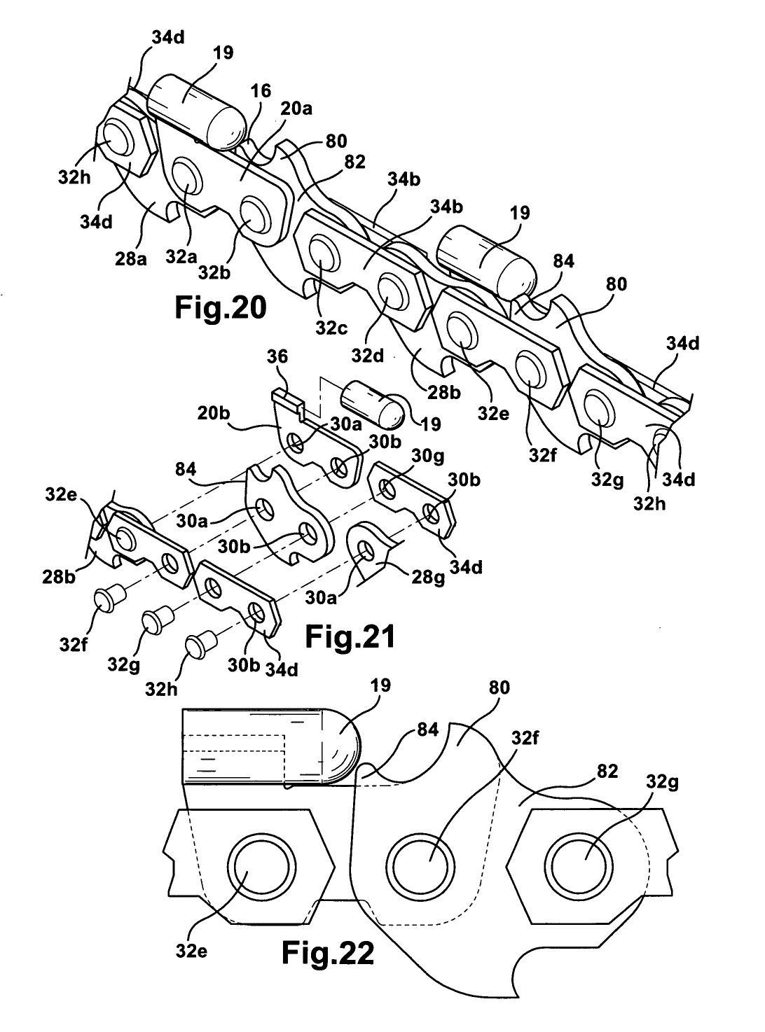

The teeth 18 alternate right- and left-handed along the chain (i.e., left-handed tooth, right-handed tooth, left-handed tooth, etc.). Referring to FIG. 4, the chain 10 has a central axis C along the chain travel direction. The left-handed teeth 18a have cutting edges 64 that extend from the central axis C outwardly on a left side L of the chain; and the right-handed teeth 18b have cutting edges 64 that extend from the central axis C outwardly on a right side R of the chain. The cutting edges 64 are adapted to cut various materials. One material that the teeth are ideally suited to cut is wood. Alternatively, the cutting edges 64 are designed for abrasion of material. Abrading teeth can have various compositions tailored to the particular material being abraded (e.g., masonry, concrete or other refractory material). Examples of teeth 19 formed of abrading material (e.g., silicon carbide) are shown in FIGS. 20-22 where like parts share like reference numerals as FIGS. 8-10.

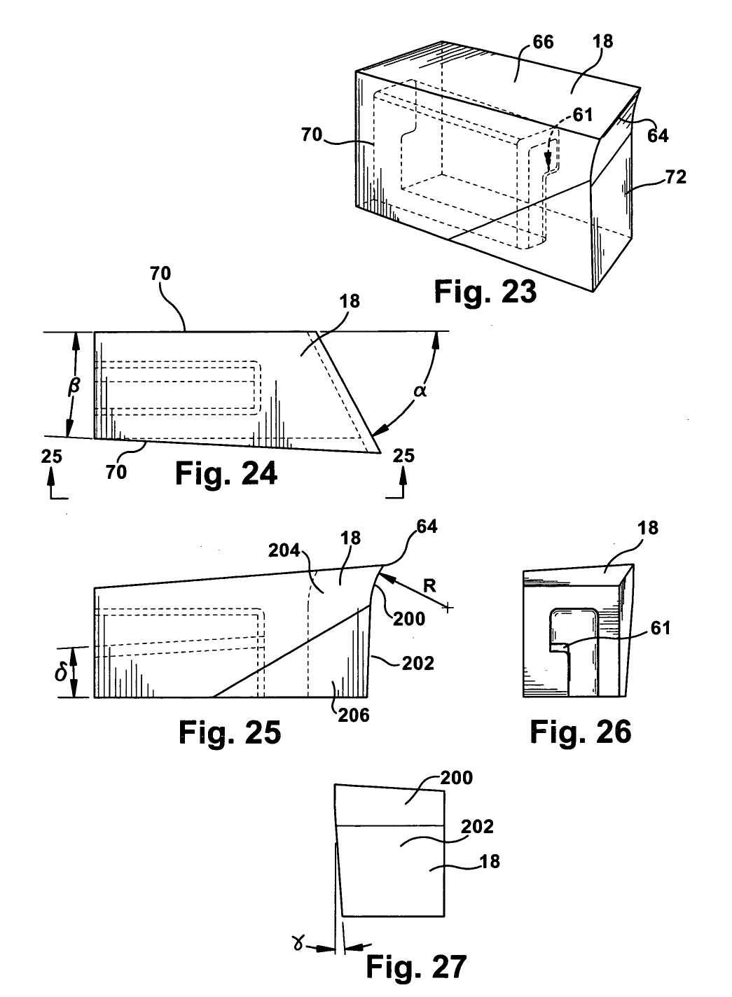

The features of the replacement teeth 18 used on the saw chain of FIGS. 1-7 are shown in FIGS. 23-27. The sharp cutting edge 64 penetrates wood fibers or other material being cut (e.g., plastic). The top surface 66 of the tooth affects the width of the saw kerf. The tooth has side surfaces 70 that extend at angle β (e.g., 3□). The tooth has a chisel angle a that finishes making the cut and pushes chips from the saw kerf, which is in the range, for example of 0 to 90□. In this exemplary design of FIGS. 23-26 the chisel angle α is 60□. A front surface 72 of the tooth forms the cutting edge 64 at an upper location. The front surface includes upper and lower surfaces 200, 202. The upper surface 200 is chamfered or concave. The concave surface has a certain radius of curvature r for a given chain pitch that is proportional to a radius of about 0.25 inch for a chain pitch of 0.750 inch. That is, about 0.25 inch is the radius of curvature for a large 0.750 pitch chain. The radius of curvature of the upper front surface 200, and in particular, of all geometries of the teeth and holding member, would be smaller for smaller pitch chains. The radius of curvature r may vary, such as being smaller than about 0.25 inch for a chain pitch of 0.750 inch. The right side of this particular tooth includes an upper surface 204 and a lower surface 206. The upper surface 204 extends generally vertically and the lower surface 206 extends inwardly at an angle γ of, for example, 5□ (FIG. 27) for providing clearance of the tooth as it cuts through material (e.g., wood). The seating tooth recess surface 61 is tapered in the particular design, e.g., at angle δ (e.g., 3.000 to 3.125 degrees), which engages a corresponding tapered seating surface 39 on the holder as disclosed in the Ser. No. 10/780,323 application.

### Safety Links and Removable or Permanent Teeth

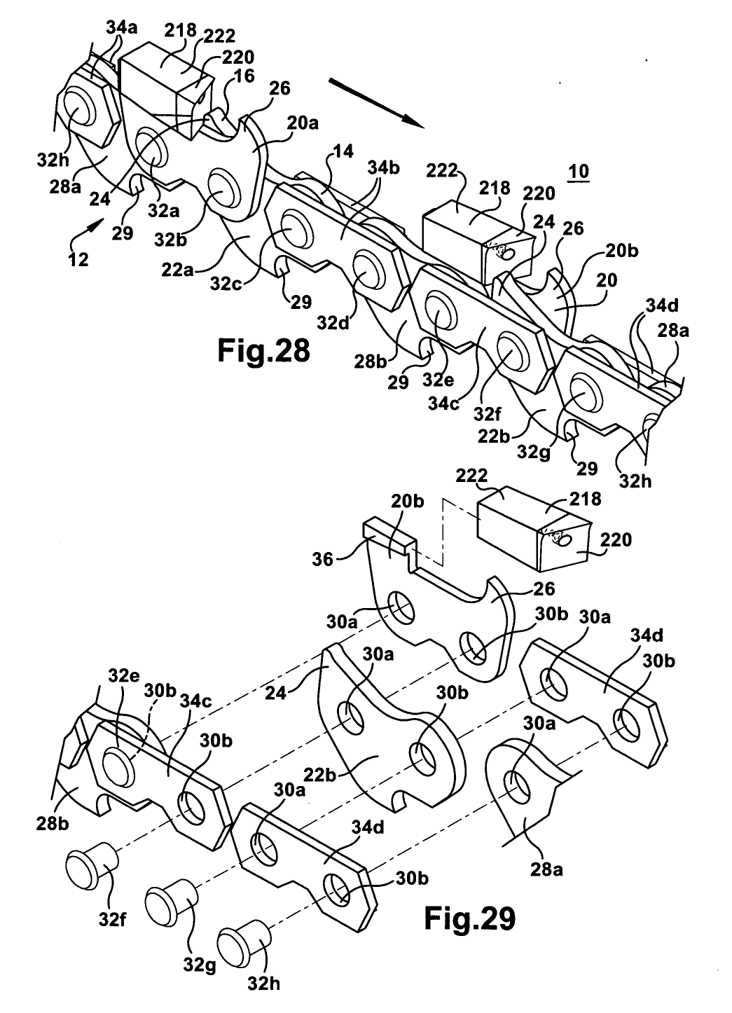

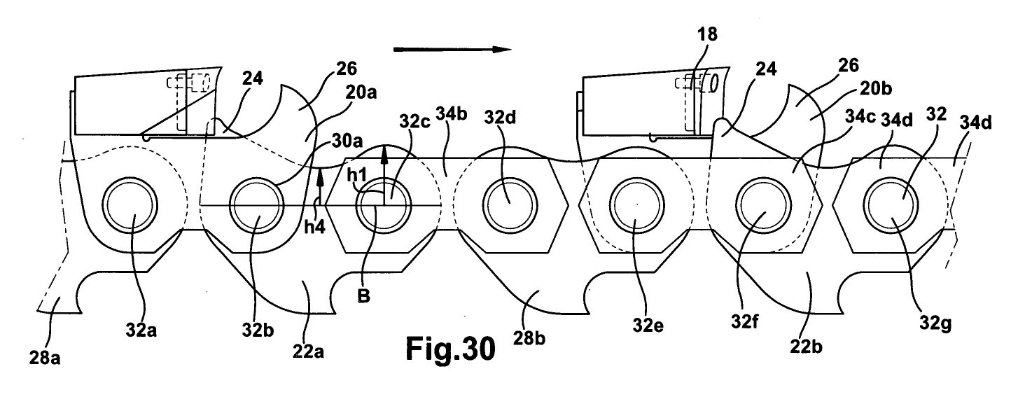

In this disclosure, like parts have like reference numbers throughout the several views. Referring to FIG. 28, the teeth 218 and/or holding links can be formed of any suitable cutting, abrading or wear-resistant materials. One suitable material is sintered and compacted particulate material, known as powdered metal as disclosed in the Ser. No. 10/780,323 patent application or known to those or ordinary skill in the art. One suitable material for forming abrading teeth is ceramic such as silicon carbide or STELLITE™ brand material.

The replaceable teeth and holding links can be made of sintered particulate metal material. The holding link may be formed of the same or different material than the tooth. The tooth can be one piece as in the Ser. No. 10/780,323 application (FIGS. 1-27). Alternatively, the tooth can include a carbide tip 220 (or tip formed of other high hardness material) and can be removably connected or permanently fastened to the holding link 20.

In the case of a removable tooth, the tooth can be formed of one piece of high hardness material (e.g., carbide) or it can be formed of a second member made of sintered particulate material and a cutting tip made of high hardness material (e.g., carbide) discussed below. However, the insert or replaceable tooth needs to be held onto the base. This can be accomplished with the wedge and taper design described in the Ser. No. 10/780,323 application. Alternatively, the safety lobe feature of the Ser. No. 11/337,294 application can suitably hold the tooth in place when the chain is used during a cutting operation.

In the event of the tooth being permanently fastened to the holding link, a bonding material rigidly connects the tooth to the holding link comprised of cement, braze, solder or polymer (e.g., epoxy resin), which is discussed in detail below. The tooth can be in one piece (e.g., one piece carbide as in FIG. 1) or it can include a high hardness tip (e.g., carbide tip as in FIG. 28). When permanently fastened there is no need for a taper on the key or keyway 36, 50. In particular, the cutting member can include a protrusion and the insert can include a recess that is adapted to receive the protrusion. The protrusion can be a key on the base and the recess can be a blind keyway in the tooth as described above.

Instead of permanently attaching the tip 220 to the second member (e.g., body 222 of the insert), the invention may employ an unthreaded hole in the tip and a threaded hole in the second member of the insert, which allows the tip and second member to be removably fastened together. Alternatively, the tip can be rigidly and permanently fastened to the second member using the bonding material. The tip can include a protrusion and the second member of the insert can include a recess that is adapted to receive the protrusion. This is described in detail below.

### Safety Chain with Carbide Inserts:

The foregoing disclosure regarding the safety chain is fully applicable to using inserts comprised of a particulate metal material containing carbide. The tooth insert 222 is made of one-piece of carbide material. Throughout this disclosure reference to carbide means any carbon based compound containing metal, for example, tungsten carbide. The carbide insert 222 and the holder 20 may include tapered surfaces as disclosed in the Ser. No. 10/780,323 application. However, such a self-locking wedge and taper arrangement is not required in the present invention. In fact, as disclosed above, the inserts 222 may be freely movable on, not rigidly connected to, the holders 20, and prevented from being dislodged in the chain travel direction by the safety lobe 24 and/or safety link described above. Avoiding the use of a taper and wedge, and instead using straight seating surfaces between the insert and holder, may increase the life of the carbide one-piece inserts. The carbide inserts 218 (FIGS. 1 and 28) are carried by holders 20 made of sintered particulate metal material. This allows for efficient manufacturing, a precise and secure fit and possibly fewer defects that reduce strength of the inserts. Using holders made of sintered particulate metal containing material is advantageous in that the complex shape of the holder can be easily formed by powder metal molding or metal injection molding at a substantially final net shape, which does not require machining of the holder.

Alternatively, the carbide inserts 218 may be carried on holders 20 formed and/or machined of steel (FIGS. 1 and 28). In addition, this final net shape may be formed precisely providing the seating surfaces at high tolerance. This is expected to prevent movement of the carbide cutters and holder, when using the self-locking wedge and taper. It would be cost prohibitive to attempt to form and machine holders to have a wedge or taper at the high tolerances described herein.

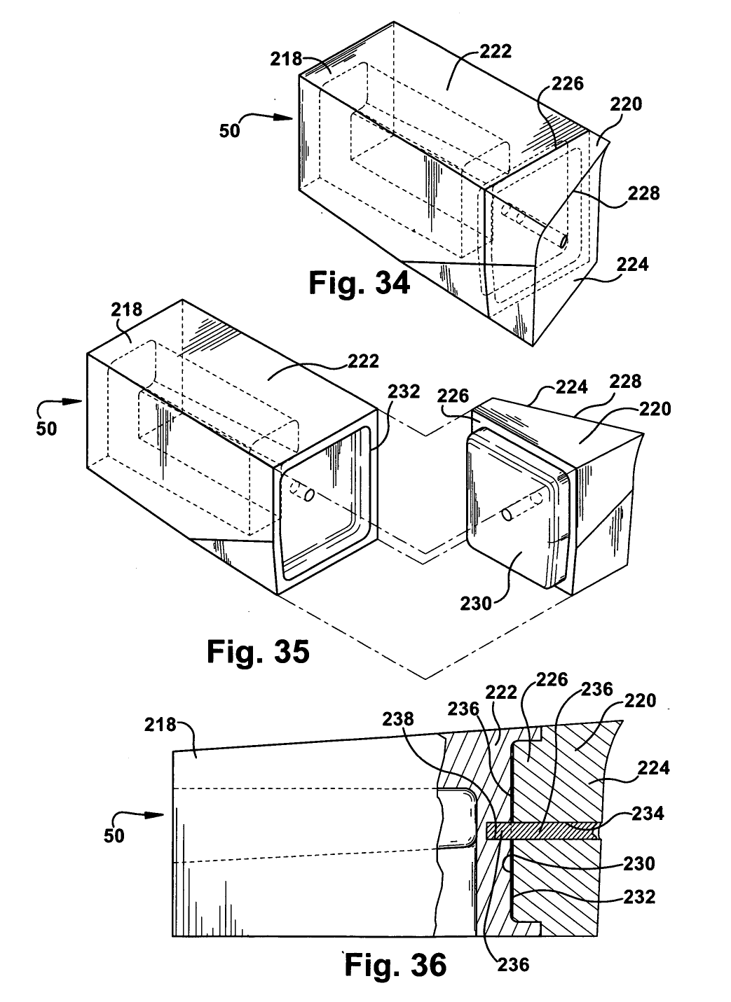

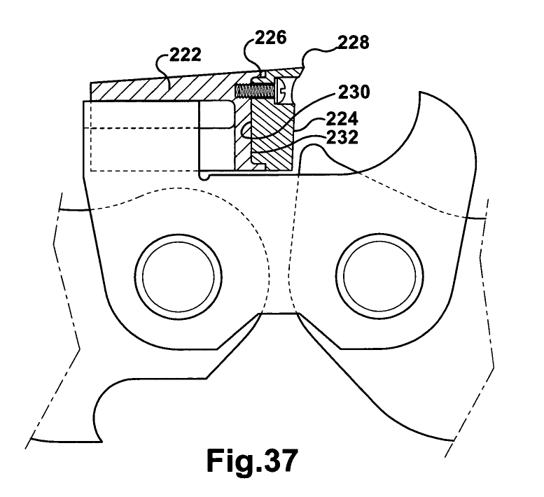

Instead of a one-piece insert, the cutters may include an insert 218 comprised of sintered particulate metal containing material and cutting members or tips 220 formed of sintered particulate metal containing material including carbide. The tip 220 can be rigidly connected to the insert body 222 by bonding and/or fastening. In the case of bonding (FIGS. 34-36), the bond between the insert and tip is formed by cementing, brazing, soldering or using epoxy. This is shown in FIG. 34 in which the tip 220 has front and rear portions 224, 226. A cutting edge 228 is disposed near the front portion. A protrusion 230 is disposed near the rear portion of the tip. The insert body 222 includes a recess 232 disposed near a front portion of the cutting insert. When connecting the tip and insert using bonding material an internal surface of the cutting member forms a through-hole 234 extending from the front portion to the rear portion of the tip. The rigid connection between the cutting member and cutting insert is formed by bonding material 236 disposed in the through-hole. An optional opening 238 may be formed in the insert body and receives the bonding material. On the other hand, the bonding material 236 may be disposed between the insert body and the tip. This may or may not include bonding material extending into an opening in the insert.

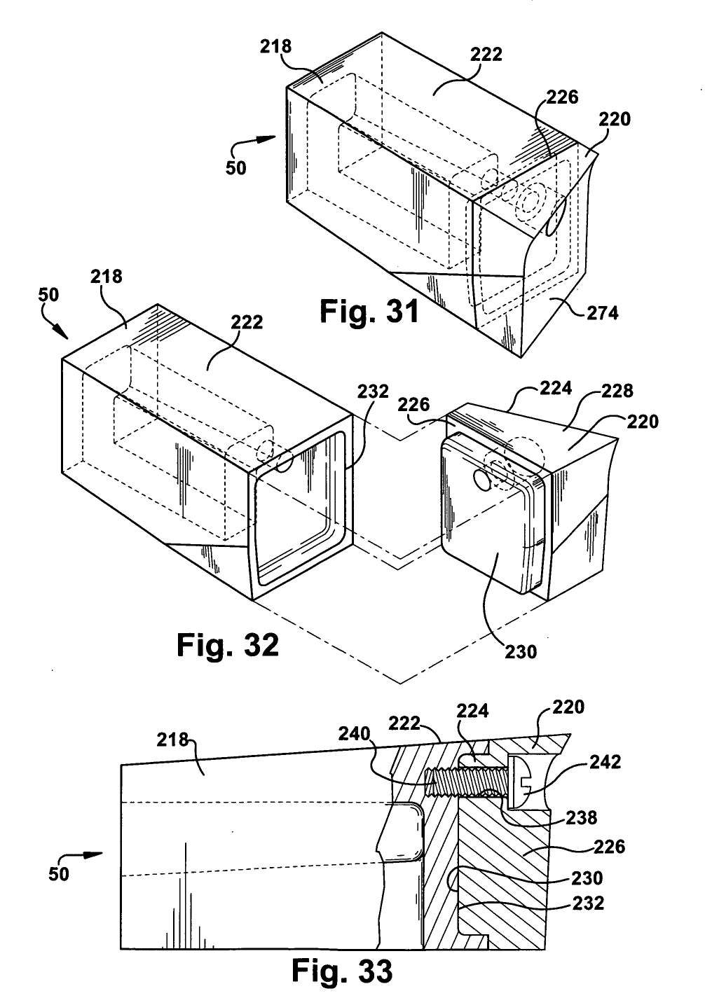

In the case of rigidly connecting the tip and insert using a fastener, as shown in FIGS. 31-33, the rear portion 226 of the cutting member includes the protrusion 230 and the front portion 232 of the insert body includes the recess 232. An internal surface of the tip forms an unthreaded through-hole 238 extending from the front portion of the tip to the rear portion of the tip. An interiorly threaded opening 240 extends from a front portion of the cutting insert into its interior in alignment with the through-hole. A fastener 242 is threaded into the threaded through-hole of the tip into the threaded opening of the insert. This enables the tip to be rigidly connected to the insert.

All embodiments of the invention that employ an insert can utilize the safety lobe and/or safety link aspects of the inventive saw chain described above to prevent the inserts from being dislodged from the chain in the direction of chain travel.

### Permanent Carbide Cutters on Saw Chain:

The inventive chain can include cutters that are permanently mounted to the holders, rather than the removable inserts described above. The permanent cutter can be one-piece including sintered particulate material containing carbide (e.g., FIG. 1). Alternatively, the permanent cutter can include a body comprised of sintered particulate metal containing material and a tip comprised of sintered particulate metal containing material including carbide (e.g., FIG. 28). The permanent cutters can be permanently, rigidly connected to the holders using any means. In particular, it is advantageous to rigidly connect the holder and cutter using bonding material formed by cementing, brazing, soldering or using epoxy. One inventive way to bond the cutter to the holder is to add the bonding material at the back of the keyway of the cutter and to position the cutter vertically in an appropriate furnace. This will enable the bonding material to travel along the entire length of the keyway and provide a rigid permanent bond between the cutter and holder. Moreover, rather than tediously bonding each insert to the holder on a chain, like carbide tips are typically brazed onto steel chain, this inventive process enables the cutters to be permanently bonded to the holders in mass production, either in a batch or continuous process.

Instead of a one-piece permanent carbide cutter on saw chain, the cutters may include a body comprised of sintered particulate metal containing material and cutting members or tips formed of sintered particulate metal containing material including carbide (e.g., FIG. 28). The tip can be rigidly connected to the body by bonding and/or fastening. In the case of bonding, the bond between the body and tip is formed by cementing, brazing, soldering or using epoxy. This is shown in FIG. 34. When connecting the tip and body using bonding material the rigid connection between the tip and body is formed by bonding material disposed in the through-hole. An optional opening may be formed in the body that also receives the bonding material. On the other hand, the bonding material may be disposed in the through-hole and between the body and the tip. This may or may not include bonding material extending into an opening in the body.

In the case of rigidly connecting the tip and body using a fastener, as shown in FIG. 31 a threaded opening extends from a front portion of the body into its interior in alignment with the unthreaded through-hole. A fastener is threaded into the threaded hole of the tip into the threaded opening of the body. This enables the tip to be rigidly connected to the body.

The insert or cutting member formed of sintered particulate material can be permanently bonded to a machined steel holder in which the insert or cutting member includes one of a precisely formed recess or protrusion and the holder includes the other.

Turning once again to the Safety Device Application, FIGS. 3 and 4 show a left side connector strap 34a has a downstream hole 30a aligned with an upstream hole 30b of a drive link 28a and with a downstream hole 30a of a right-handed holding link 20a. The links are secured with a rivet 32a. The drive link 28a is sandwiched between the connector strap 34a and the right-handed holding link 20a. The upstream hole 30b of that left side connector strap 34a is aligned with the downstream hole 30a of a safety link 22a and with an upstream hole 30b of the right-handed holding link 20a. The links are secured with a rivet 32b. The safety link 22a is sandwiched between the left side connector strap 34a and the right-handed holding link 20a. The upstream hole 30b of the safety link 22a is aligned with downstream holes 30a of a pair of connector straps 34b and secured by rivets 32c. The upstream holes 30b of the connector straps 34b are aligned with a downstream hole 30a of a drive link 28b and secured by rivets 32d. The downstream hole 30a of the next right side connector strap 34c is aligned with an upstream hole 30b of the drive link 28b and with a downstream hole 30a of a left-handed holding link 20b. The links are secured by a rivet 32e. The drive link 28b is sandwiched between the connector strap 34c and the left-handed holding link 20b. The upstream hole 30b of that connector strap 34c is aligned with a downstream hole 30a of the next safety link 22b and with an upstream hole 30b of the left-handed holding link 20b. The links are secured with a rivet 32f. The safety link 22b is sandwiched between the left-handed holding link 20b and the right connector strap 34c. An upstream hole 30b of the safety link 22b is aligned with downstream holes 30a of a pair of connector straps 34d. The safety link 22b is sandwiched between the connector straps 34d. The links are secured with a rivet 32g. An downstream hole 30a of the drive link 28a is aligned with upstream holes 30b of the pair of connector straps 34d. The drive link 28a is sandwiched between the connector straps 34d. The links are secured by a rivet 32h (FIG. 1). The sequence of components of the chain repeats in this or a similar fashion depending on the chain design (e.g., full compliment, semi-skip (half skip) and full skip chains).

Referring to FIG. 3, the safety link 22a includes an imaginary reference line B that intersects the upstream and downstream rivet holes 30b, 30a of the safety link. The body of the safety link has a height h1 along the arrow at a location perpendicular to the reference line B and intersecting a centerpoint of the upstream hole 30b of the safety link 22a. The safety lobe 24 of the safety link extends to a height h2 along the arrow perpendicular to the reference line B and intersecting the centerpoint of the downstream hole 30a of the safety link 22a. The safety lobe 24 is located in a region in the chain travel direction between the line h2 and a line h3 extending perpendicular to the reference line B at the most downstream end surface 73 of the safety link. The height h2 is greater than the height h1. The central portion of the body of the safety link has a height h4 perpendicular to the reference line B at the midpoint between lines h1 and h2. h2<h1<h4. In other words, the safety lobe 24 (height h2) extends at a maximum height of the safety link that is higher than the upstream portion of the safety link (height h1), which extends higher than the central portion of the safety link (height h4) that is approximately at a minimum height of the safety link.

In a method of safely operating saw chain of the first embodiment, the saw is operated to move the chain by powering the motor to rotate the chain upon engagement of the drive links of the chain with the chain saw sprocket and optional sprocket at the end of the guide bar (not shown) in a known manner. Initially the teeth are all new, sharpened or contain a maximum amount of cutting or abrasion material (e.g., sharpened teeth). The saw is used to cut or abrade the intended material. During operation of the saw, at which time the chain rotates around the bar, dislodging of the teeth from the holders in the chain travel direction is prevented by the safety lobes. This ensures safe operation in that the dangerous condition in which whole teeth are dislodged in the chain travel direction is avoided. Breakage of portions of the teeth may be unavoidable, as occasionally occurs in the breakage of soldered tips from steel teeth. However, this condition can be accounted for with proper safety goggles and other conventional safety equipment and procedures. The saw is shut off, stopping movement of the chain. The chain is removed from the saw.

Once it is determined by the user that one or more teeth should be replaced, such as due to damage or wear of the teeth, the links are pivoted so as to move the safety link out of a path of an adjacent tooth needing replacement. Referring to FIG. 7, safety link 22b is pivoted downward out of the path of the tooth 18 ( in the clockwise direction of arrow 73). This enables the tooth 18 to be removed from the holding member 36b in the direction shown by arrow 75 and replaced with a new or replacement tooth 18 in the direction opposite to arrow 75. The chain is pivoted back to an operational position. That is, the safety link 22b is pivoted in the counterclockwise direction. The chain is then re-installed onto the bar of the saw. This entire operation can be done quickly and economically compared to sharpening teeth or replacing the entire chain. In addition, cutting or abrading is performed safely despite the use of the quickly replaceable teeth.

The saw chain of the present invention may include various modifications that would be apparent to those of ordinary skill in the art in view of this disclosure. In this disclosure like components are given like reference numbers throughout the several views. As shown in FIGS. 8-10, one modification compared to the chain shown in FIGS. 1-7 is that the depth gauges or rakers 80 are disposed on the safety links instead of on the holding links 20. This design is suitable for automated saws in which kickback occurs when cutting wood near the end of the bar, where there is a reduced safety concern.

Referring to FIGS. 9 and 10, the safety link 82 includes an imaginary reference line B that intersects the upstream and downstream rivet holes 30b, 30a of the safety link. The body of the safety link has a height h5 along the arrow at a location perpendicular to the reference line B and intersecting a centerpoint of the upstream hole 30b of the safety link 82. The safety lobe 84 of the safety link extends to a height h9 along the arrow perpendicular to the reference line B at the most downstream end surface 86 of the safety link. The safety lobe 84 is located in a region in the chain travel direction between the line h9 and a line h8 extending perpendicular to the reference line B at an intersection of the centerpoint of the downstream hole 30a. The central portion of the body of the safety link has a height h6 perpendicular to the reference line B at the midpoint between lines h5 and h8 from the hole centerpoints. The raker 80 extends to a height h7 along the arrow perpendicular to the reference line B and is located approximately between lines h6 and h8. h7<h9<h5. In other words, the raker 80 extends at a maximum height (h7) of the safety link, the upstream portion extends to a minimum height (h5) and the safety lobe 84 (height h9) extends at an intermediate height between heights h7 and h5.

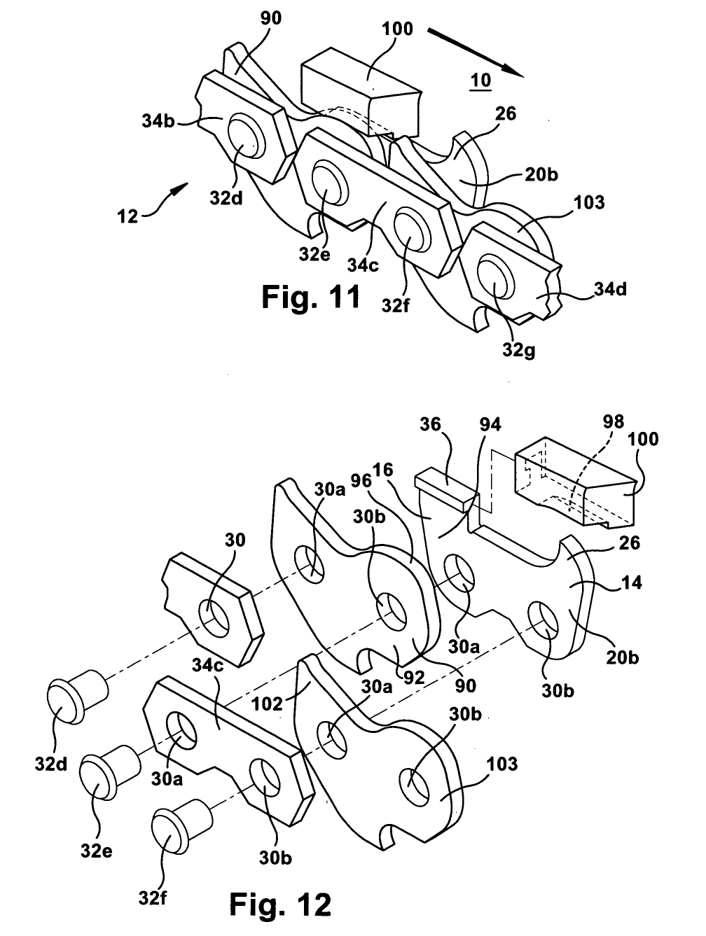

Referring to FIGS. 11-14, in other embodiment the link that is downstream of the holding link (e.g., a drive link 90 as shown in FIG. 11) has its upstream end 92 pivotably fastened to the downstream end 94 of the left side holding link 20b. The link 90 is also a safety link and includes a cam-shaped or arcuate surface 96 at its upstream end, which is received in a cam-shaped or arcuate recess 98 formed in a lower surface of a corresponding tooth 100 (FIG. 12). The arcuate surface 96 and arcuate recess 98 may have other shapes and sizes as would be appreciated by one of ordinary skill in the art reading this disclosure. This safety feature ensures that the teeth are seated against the front of the keys 36 and limits tooth movement during operation of the saw especially when no means for retaining the teeth on the holding members is employed on the holding members (e.g., no wedge and taper):

In the design shown in FIGS. 11 and 12, the drive link 90 and the safety link 22 are the same link. However, the drive and safety links could be separate links on the chain depending on the number of links between holding links. In addition, it might be desirable to provide the upstream safety link 22 with one design and the downstream link 90 with a different design. The safety cam member 96 is usable alone, or in conjunction with the safety lobe 102 and/or means on the holding members for retaining the teeth to the holding members. If the teeth and holding members have the corresponding wedge and taper design, or some other means for retaining the teeth on the holding members, the cam safety member 96 and cam recess 98 alone, without the upstream safety lobe 102, may be sufficient to prevent movement of the teeth on the holders in the direction of chain travel. Even without the wedge and taper design or other means on the holder for retaining the teeth in position, in which case the teeth can move freely on the holding members, the safety cams 96 and cam recesses 98 alone may be sufficient to retain the teeth on the holding members without the need for the upstream safety lobe 102. However, those of ordinary skill in the art will appreciate in view of this disclosure the benefit of having multiple safety features: the combination of the upstream safety lobe 102 of safety link 103 and the safety cam 96/cam recess 98, whether on the same or different links. This combination of safety features can be used with or without the wedge and taper design or other means for retaining the teeth in place on the holders.

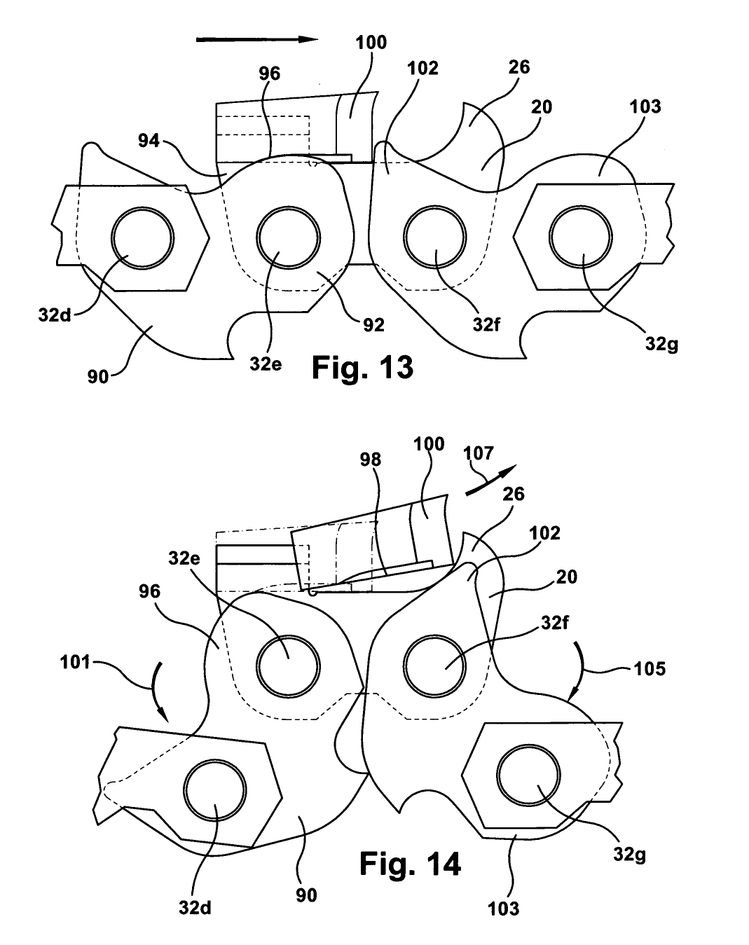

In the tooth replacement procedure shown in FIGS. 13 and 14, the chain is removed from the saw. The tooth 100 can be removed by rotating the link 90 counterclockwise along arrow 101 such that the cam surface 96 does not engage the cam recess 98. If the safety lobe 102 is also used as shown in FIG. 14, the safety link 103 is rotated clockwise along arrow 105 so that the safety lobe 102 does not obstruct movement of the tooth 100 in the chain travel direction. The tooth 100 is then removed from the holding member in the direction of arrow 107. If the tooth is retained using the wedge and taper, it is removed with a suitable tool. A replacement tooth is installed in a direction opposite the arrow 107. The links 90 and 103 are rotated clockwise and counterclockwise, respectively, and the chain is re-installed on the saw.

### Safety Rotational Cutting Device:

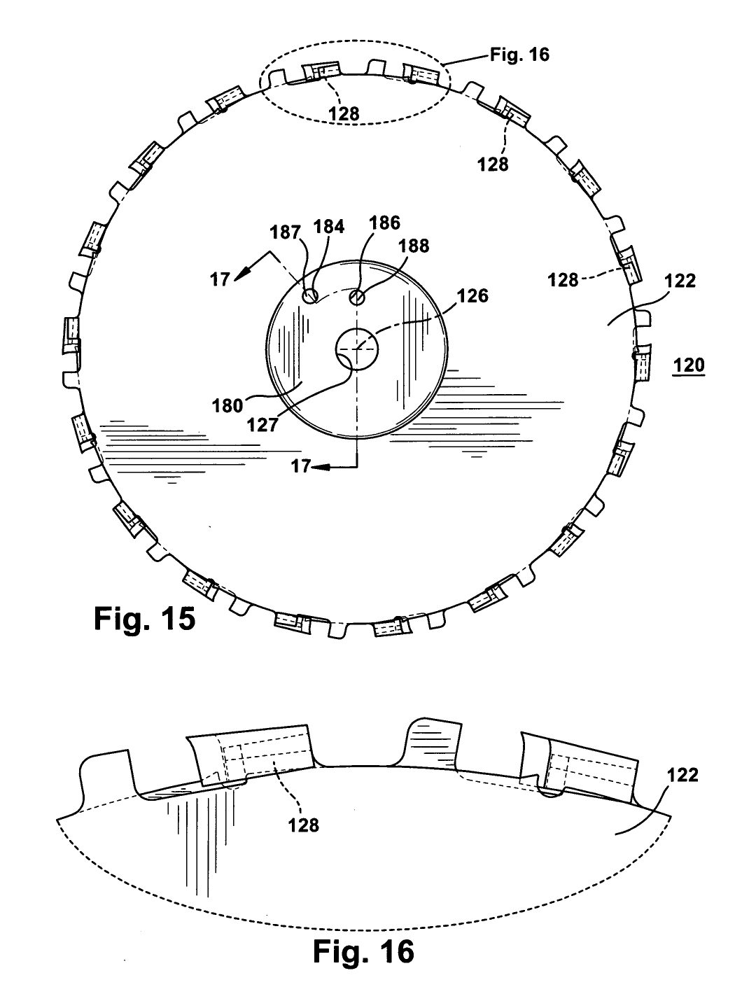

Referring to FIGS. 15-19, in another embodiment a safety rotational cutting device 120 for a saw includes left and right circular blades 122, 124 adapted for rotation about common central axis 126 and disposed in a fixed position during operation of the saw so as to prevent relative rotation of the blades. Each component of the device includes an upstream end and a downstream end relative to a rotational direction of travel of the blades (e.g., upstream end 121 and downstream end 123 of holding member 128). A plurality of left holding members 128 extend from an outer peripheral surface 130 of the left blade and are spaced apart from one another around the circumference of the left blade. A plurality of right holding members 132 extend from a peripheral surface 134 of the right blade and are spaced apart from one another around the circumference of the right blade. A plurality of left-handed replaceable teeth 136 are adapted to be removably retained on the left holding members 128. A plurality of right-handed replaceable teeth 138 are adapted to be removably retained on the right holding members 132. A plurality of left safety lobes 140 are each spaced apart from each other around the circumference of the left blade 122 and each is disposed upstream of one of the right holding members 132. One of the left safety lobes 140 extends in proximity to one of the right-handed teeth 138 effective to prevent the tooth 138 from being dislodged from the right holding member 132 during rotation of the blades. A plurality of right safety lobes 142 are each spaced apart from each other around the circumference of the right blade 124 and each is disposed upstream of one of the left holding members 128. One of the right safety lobes 142 extends in proximity to one of the left-handed teeth 136 effective to prevent the tooth 136 from being dislodged from the left holding member 128 during rotation of the blades.

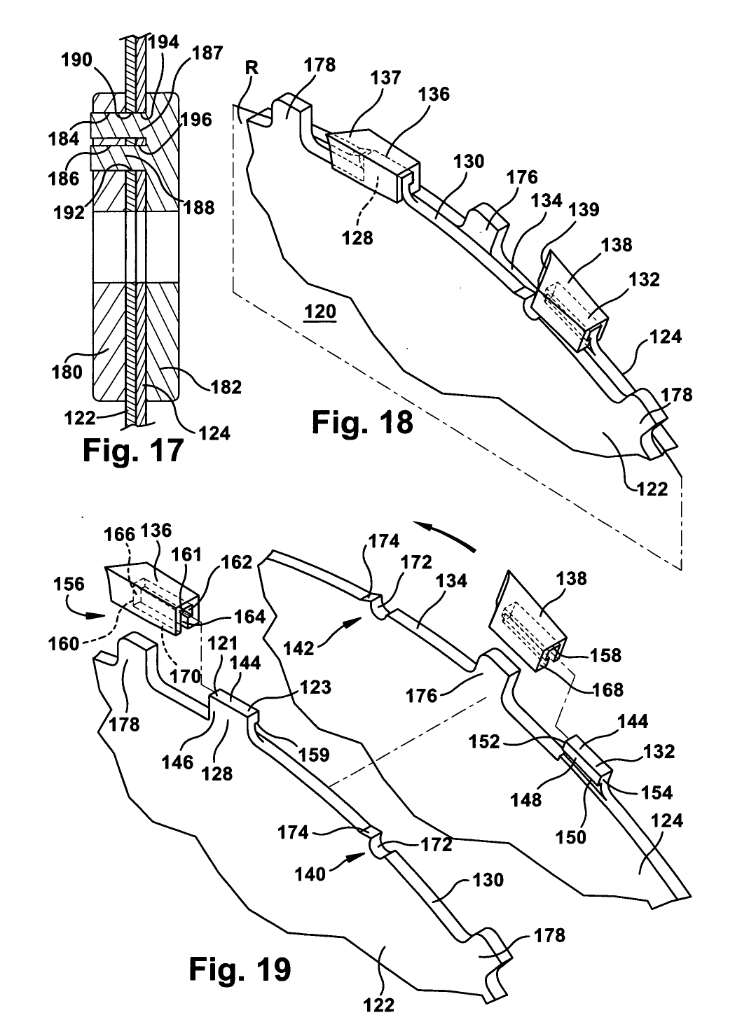

Referring to FIGS. 18 and 19, the holding or key members have at least one seating surface. The key member has an inverted-L shape and includes a top surface 144, a long side surface 146, first and second short side surfaces 148, 150, and front and back surfaces 152, 154. Each tooth 136, 138 includes a recess 156 configured and arranged to receive the key member. The recess has an inverted-L shape that corresponds to the inverted-L shape of the holding member and includes a top recess surface 158, a long side recess surface 160, first and second short side recess surfaces 162, 164, and a front recess surface 166. The L-shaped recess is open at a back surface 168 and bottom surface 170 of the tooth. The recess includes at least one seating surface. Seating surfaces are surfaces of the tooth and holding member that contact each other. It will be appreciated by those of ordinary skill in the art in view of this disclosure that the figures show but one example of a suitable design for the holding member and teeth. The tooth could include a stud and the holding member could include a recess that receives the stud. The holding member and recess could have some other shape such as a T-shape. These and many other variations in the design of the teeth and holding members are possible and contemplated to be within the scope of the present invention.

Each safety lobe 140, 142 includes a trough 172 located below the peripheral surface 130, 134 of the blades and a crest 174 upstream of the trough extending above the peripheral surface 130, 134 of the blade. Optional depth gauge members or rakers 176, 178 extend higher than the crest of the safety lobes.

More specifically, referring to FIGS. 18 and 19, right holding member 132 on the right blade 124 receives a right-handed tooth 138. Proceeding relative to the rotational direction of the blades, the safety lobe 140 on the left blade 122 is upstream of the tooth 138 when the blades are fixedly secured to each other, preventing the tooth from being dislodged from the right holding member 132. A raker 176 on the right blade is upstream of the left safety lobe 140. Next, a left holding member 128 on the left blade 122 receives a left-handed tooth 136. The safety lobe 142 on the right blade 124 is upstream of the tooth 136 when the blades are fixedly secured to each other, preventing the tooth from being dislodged from the left holding member 128. A raker 178 on the left blade is upstream of the right safety lobe 142. This pattern of components continues around the circumference of the blades. Variations in the number of links between holding members, as in the case of the chain shown in FIG. 1, fall within the scope of this embodiment of the invention.

### Carbide Teeth on One or Two Blades

This embodiment of the invention can use one or two blades to achieve safe operation. In the case of two blades, the safety lobes of the right blade are positioned upstream of the left-handed teeth and the safety lobes of the left blade are positioned upstream of the right-handed teeth. The left and right blades are fixed to each other during operation by being fastened onto the arbor, which extends through the hole at the rotational axis of each blade. Once the blades are separated the teeth can quickly and easily be removed from the holding members in a manner similar to the previous embodiments as there is no further obstruction. Replacement teeth are installed on the holding members. Then, the blades are once again fixed to each other and fastened onto the arbor effective to enable the safety lobes of one of the blades to prevent the teeth of the other blade from being dislodged from the holders.

When viewed along the circumference of the blades, the teeth of the circular saw members alternate right- and left-handed. Referring to FIG. 18, a central imaginary reference plane R is disposed between the saw blades perpendicular to the rotational axes 126. The left-handed teeth 136 have cutting surfaces that extend from the central plane R outwardly on a left side of the blades. The right-handed teeth 138 have cutting surfaces that extend from the central plane R outwardly on a right side of the blades. The teeth are designed with sharp cutting surfaces adapted to cut various materials. The teeth are especially designed to effectively cut wood. Alternatively, the teeth can be designed to include a surface adapted for abrasion of material. Teeth adapted for abrasion can be formed of various materials adapted to the material being abraded (e.g., brick, concrete or other refractory material). The teeth in all embodiments of the invention may also have a combination cutting/abrading function depending on the design of the teeth and the type of material the saw acts upon.

Left and right arbor clamping disks 180, 182, having smaller diameters than the blades 122, 124, are disposed on the sides of the blades and clamp the blades between them. The arbor disks each includes two offset pin openings 184, 186 or one or two pins 186, 188. In this design the right arbor disk includes two pins and the left arbor disk includes two holes. As a further possibility instead of offset bolt patterns, large and small pins could be used to prevent improper installation of the blades. The blades also include two offset pin openings 190, 192 (left blade) and 194, 196 (right blade). The openings 190, 194 are on a different pin pattern from the openings 192, 196. Relative to the central axis, the holes 190, 194 lie on the circumference of a circle of one diameter and the holes 192, 196 lie on the circumference of a circle of a second diameter that is smaller than the first. The bolts or pins 186, 188 are welded or integrally formed on one or both of the arbors. In FIG. 17 the pins 186, 188 are welded to the right arbor disk 182. The blades and arbor disks are positioned to align the pin holes of both arbors and both blades with one another. That is, holes 184 and 186 of the left arbor disk 180 are aligned with the holes 190 and 192, respectively, of the left blade 122. The holes 194 and 196 of the right blade 124 are aligned with the holes 190 and 192 of the left blade 122. The pins 186, 188 protrude through the aligned holes. That is, pin 186 extends through holes 194,190 and 184, and the pin 188 extends through holes 196,192 and 186. Because of the use of the offset pin patterns, it is not possible for the user of the saw to install the blades incorrectly (e.g., backwards). In addition, the alignment of the pins in the holes of the blades precisely aligns the safety lobes of each blade relative to the teeth of the other. Another advantage of the pins projecting in the holes of the blades is that the blades cannot rotate relative to each other when the saw is used. That is, the blades are fixed in position relative to each other.

### Carbide Teeth on One Blade

In the case of using one blade, a circular body of the blade is metal and metal base members extend from a periphery of the body and are spaced along its circumference. The holders may be machined from a blank plate or may be riveted onto the periphery of a plate. The holders on circular blades may be formed of sintered particulate material. The terms “one blade” used herein mean blades that are not connected together as described above but include a plurality of spaced single blades fastened to one or more arbors used in an automated cutting operation. The base members can be machined from the body. The cutting members are formed of one or two pieces that are either permanently attached to the base members using bonding material or are removably disposed on the base members as with fasteners.

### Removable or Permanent Carbide Teeth on Blades:

The teeth and/or holding links of the blades can be formed of any suitable cutting, abrading or wear-resistant materials. One suitable material is sintered and compacted particulate material, known as powdered metal as disclosed in the Ser. No. 10/780,323 patent application or known to those or ordinary skill in the art. One suitable material for forming abrading teeth is ceramic such as silicon carbide or STELLITE™ brand material. A suitable hard and tough material is tungsten carbide.

The replaceable teeth and holding links of the blades can be made of sintered particulate metal material in the first embodiment of the present invention. The holding link may be formed of the same or different material than the tooth. The tooth can be one piece as in the Ser. No. 10/780,323 application. Alternatively, the tooth can include a carbide tip and can be removably connected or permanently fastened to the base.

In the event of a removable tooth, the tooth can be formed of one piece of high hardness material (e.g., tungsten carbide) or it can be formed of a second member made of sintered particulate material and a cutting tip made of high hardness material (e.g., tungsten carbide). However, the insert or replaceable tooth needs to be held onto the base. This can be accomplished with the wedge and taper design described in the Ser. No. 10/780,323 application. Alternatively, the safety lobe feature of the Ser. No. 11/337,294 application (two blades) can suitably hold the teeth in place when the blades are used during a cutting operation.

In the event of the tooth being permanently fastened to the holding member, a bonding material rigidly connects the tooth to the base member. The bonding material is comprised of cement, braze, solder or polymer (e.g., epoxy resin). The tooth can be in one piece (e.g., one piece of tungsten carbide) or it can include a high hardness (e.g., tungsten carbide) tip. When the tooth is permanently fastened to the holder there is no need for a taper on the key or keyway. In particular, the cutting member can include a protrusion and the insert can include a recess that is adapted to receive the protrusion. The protrusion can be a key on the base and the recess can be a blind keyway in the tooth as described above.

Instead of permanently attaching the tip to the second member, the invention may employ an unthreaded hole in the tip and a threaded hole in the second member of the insert, which allows the tip and second member to be removably fastened together. Alternatively, the tip can be rigidly and permanently fastened to the second member using the bonding material. The tip can include a protrusion and the second member of the insert can include a recess that is adapted to receive the protrusion.

### Manufacturing Process

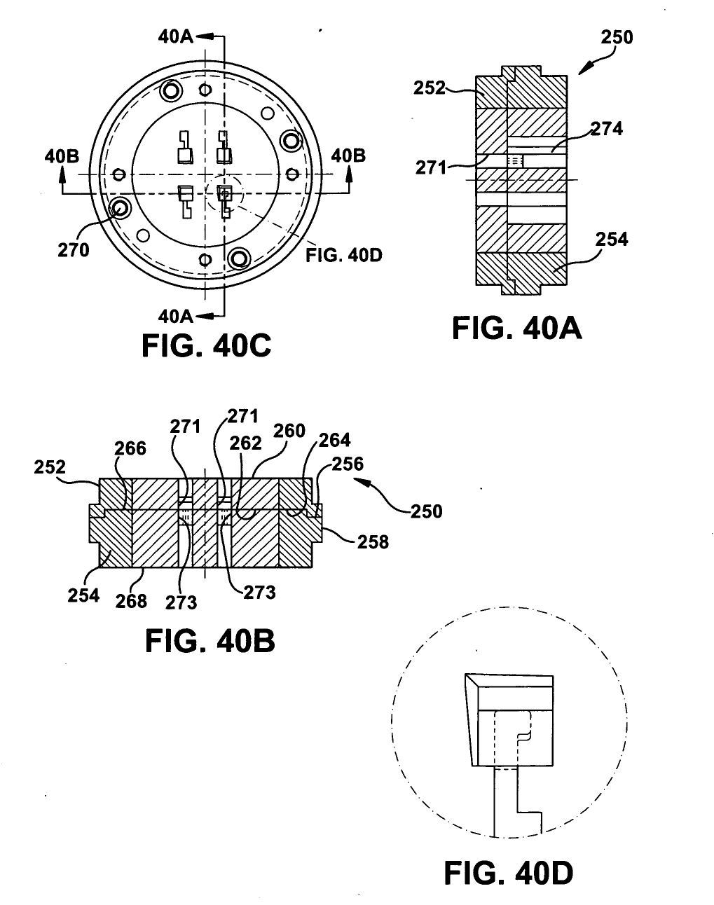

In the method of making the components of the invention comprised of sintered particulate material, a die 250 having upper and lower sections 252, 254 is used as shown in FIG. 40. Upper die section includes collar or flange 256 and lower die section includes collar or flange 258. Upper die section includes upper and lower surfaces 260, 262 spaced apart from each other. The lower surface 262 of the upper die section includes a central circular recess 264. Lower die section 254 includes upper and lower surfaces 266, 268 spaced apart from each other. The upper die section includes a plurality of die cavities 271 that each form a front of the sharp component including the sharp edge (FIG. 40). The die sections include suitable threaded bolt holes 270. The lower die section includes a plurality of die cavities 273 that each form a rear of the component including a blind keyway. Although the figures depict manufacture of a keyway in the insert, the holders may be similarly manufactured to include a key or keyway and the insert may be similarly manufactured to include a key.

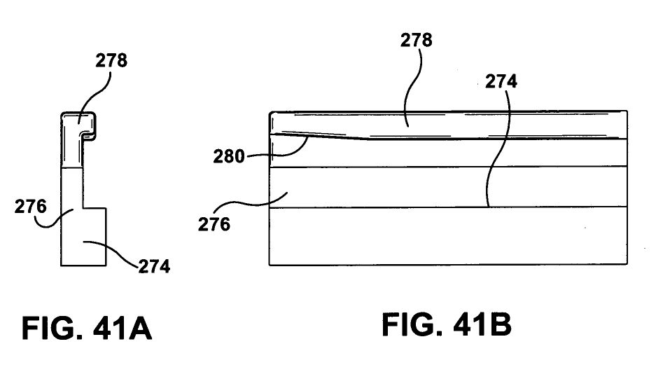

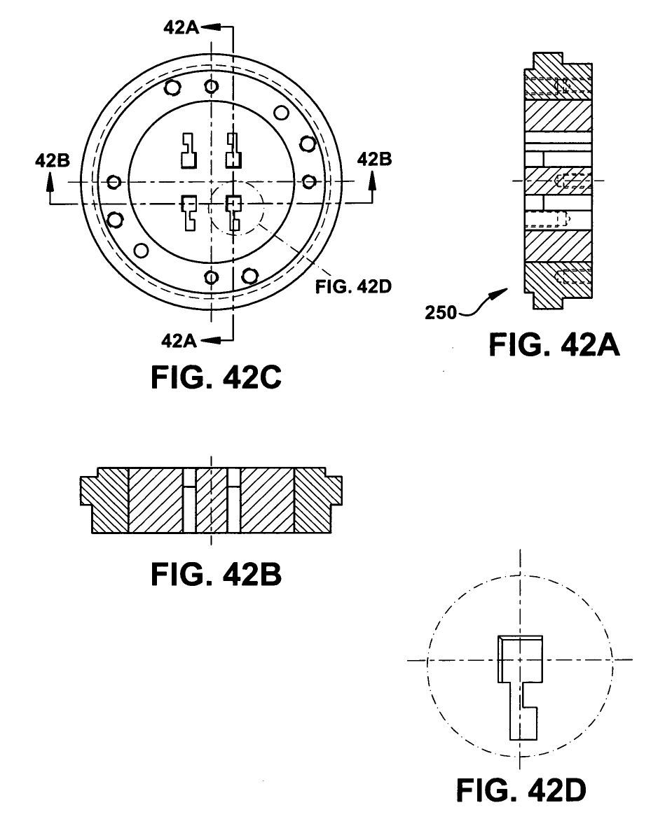

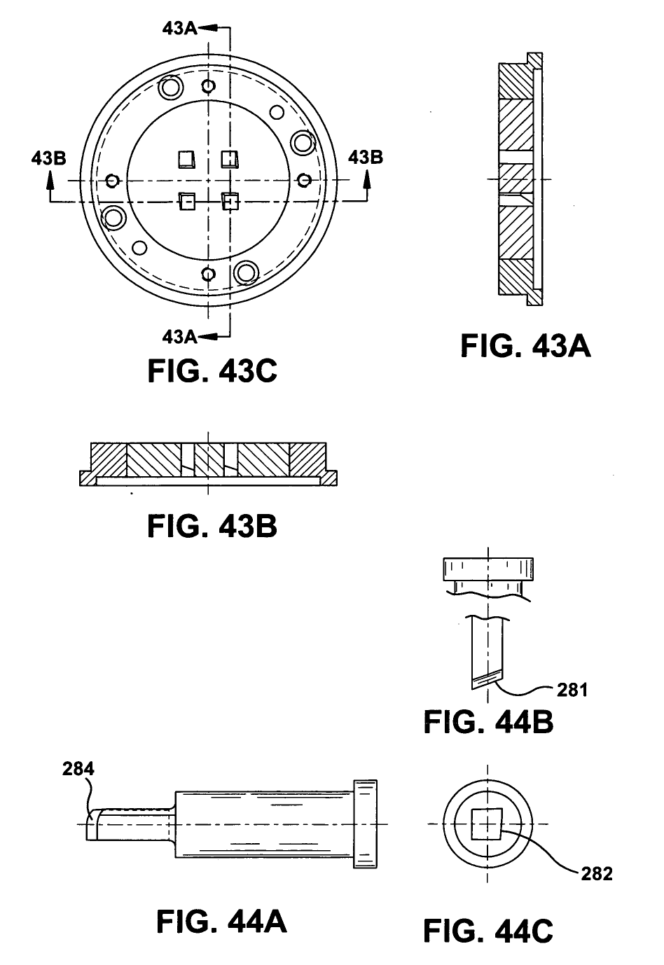

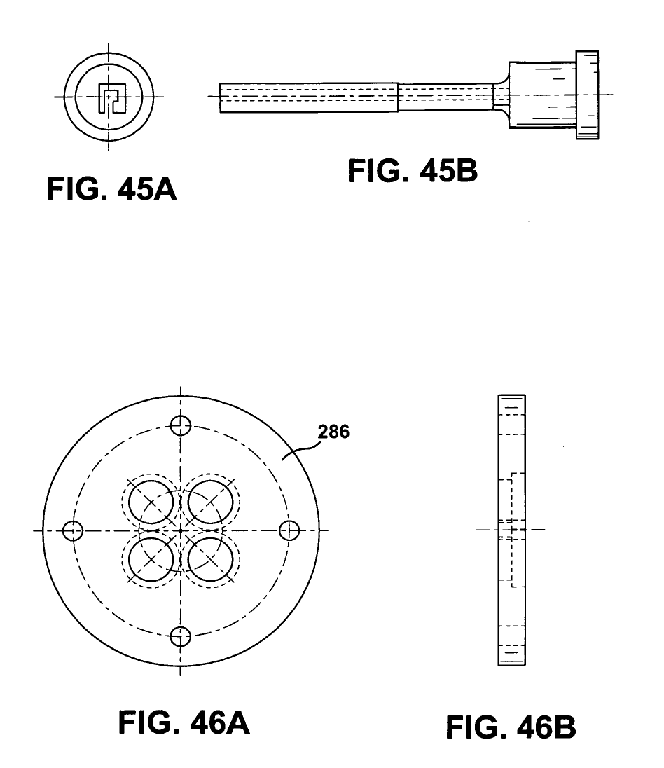

More specifically, referring to FIGS. 40 and 41, the lower die section includes a core pin 274. The core pin has a block portion 276 with a chair like shape that fits into a correspondingly shaped recess and is captured between the die sections. A key portion 278 extends into the die cavity for making the part.

The core pin has a shape that forms the blind keyway 50 from the rear toward the front of the part (i.e., from the bottom toward the top of the die). The L-shaped core pin (end view: FIG. 41A) may be tapered at 280 (e.g., at about 3 degrees), which provides a taper to the corresponding interior surface of the blind keyway. Similarly, the upper punch is configured and extends into the upper die so as to form an angled surface 281 and sloped surface 284 of the part (FIGS. 44B and 44A). The upper punch also has a surface 282 that forms a relief in the part. The upper punch extends a distance into the upper die without reaching the core pin, forming the front of the part and its cutting edge 228. This process is unique in that it normally results in a final net shape of the part without sharpening the edge. However, the invention is considered to have produced a final net shape component if the only remaining step is to optionally sharpen the edge further by grinding. The lower punch occupies the lower die section completely but has an L-shaped keyway cavity in which the core pin is received. Therefore, the lower punch travels upwardly around the core pin in the lower part cavity 273 (FIG. 40B).

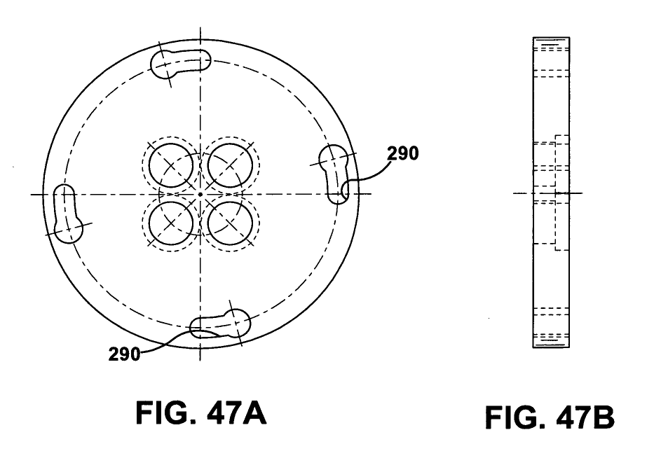

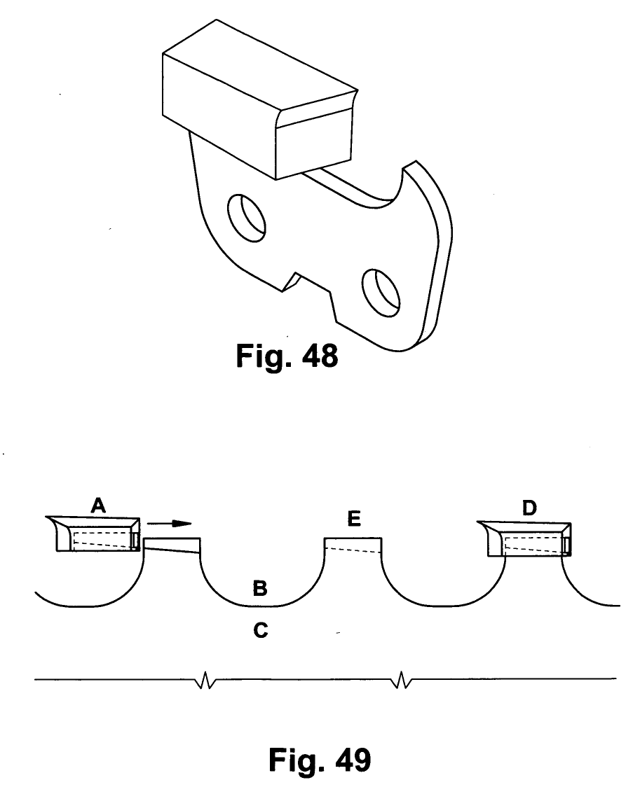

Each of the upper and lower rams of the press has a clamp bolted to it. The clamp includes suitable bolts and alignment dowels that extend from the clamp into the die. An upper clamp plate 286 is shown in FIG. 46 while a lower clamp plate 288 is shown in FIG. 47. One or both clamps may include circumferentially extending sliding holes 290 that enable the clamps to be adjusted.

The die setter places the upper punch into the die and then moves the clamp onto the punch. The bottom punch may always remain in the lower die section. Ram travel is adjusted and samples are run to determine the ram travel that is appropriate for achieving suitable density (e.g., strength of the component).

During operation, the lower ram is moved to a particulate loading position. A powder shoe arm adds powder to the part cavity in the die sections. The bottom and top punches converge, compacting the powder in the shape of the part during pressing. The top punch moves out of the die and the lower punch continues upward to eject the part from the die sections.

In particular, the lower punch and core pin remain in the die during normal manufacturing. However, when the core pin becomes worn it is easily removed and replaced in the die by another core pin. The upper punch is removed from the die after forming the green part. The lower punch is then raised to eject the part from the die. This is carried out in multiple dies at the same time, which results in rapid production of the final net shape, fully sharp parts. The green parts are then sintered in a furnace (e.g., under a vacuum) until the part is provided with a density approaching theoretical density forming the component having sintered particulate material. The components can be deburred or sharpened if desired but this is not necessary.

The particular exemplary embodiments of the invention will now be described in most cases without further discussion of the optional safety lobes. These may overlap the foregoing discussion in connection with safety links. A first embodiment of the invention features carbide saw chain comprising a plurality of links including drive links, cutting links and tie straps that are pivotally interconnected by rivets. The cutting links include a base member comprised of sintered particulate metal material and a cutting member comprised of sintered particulate metal material that includes carbide. The cutting member includes a sharp cutting edge. The base member includes holes for receiving the rivets, and one of the base member and the cutting member includes a first projecting seat surface and the other includes a second recessed seat surface configured to receive the first seat surface.

Referring now to specific features of the first embodiment, as pertains to permanent connection, a bonding material is disposed between the first and second seat surfaces and is selected from the group consisting of cement, braze, solder, polymer and combinations thereof. The cutting and base members are formed by a process that provides said first seat surface and said second seat surface with a final net shape and sharp cutting edge. In an optional step the cutting member edge can be further sharpened, but this is not necessary. This process is selected from the group consisting of powder metal molding, metal injection molding, investment casting and combinations thereof. The cutting member and tie straps are disposed on sides of the chain and the drive links are disposed at a center of the chain. The base member includes a body portion extending to a height of the tie straps along the chain and the first seat surface is part of the base member and located above the body portion. The first seat surface is a key formed on the base member and the second seat surface is a keyway formed in the cutting member. The key and keyway may be tapered or untapered. The key and keyway can have an L-shape or inverted L-shape. The cutting member is separate from the drive link.

Referring now to particular aspects of the invention pertaining to insert teeth with tips, the cutting member includes the cutting insert and a cutting tip comprised of sintered particulate metal material including carbide. The cutting tip includes a sharp cutting edge. One of the cutting insert and cutting tip includes a protrusion and the other includes a recess configured to receive the protrusion. The cutting insert and cutting tip are rigidly connected to each other. No fastener is needed for preventing the cutting insert from being removed from the base member in a direction of chain travel. The rigid connection includes bonding material selected from the group consisting of cement, braze, solder, polymer and combinations thereof. The cutting member and cutting tip are formed by a process that provides them with a final net shape except for the cutting edge that can be sharpened. This process is selected from the group consisting of powder metal molding, metal injection molding, investment casting and combinations thereof. The cutting member is separate from the drive link. The base member includes a body portion and a depth gauge located upstream of the cutting tip. The base includes a key and the cutting member includes interior walls that form a keyway configured to receive the key. The key and keyway are untapered. The cutting tip has front and rear portions. The cutting edge is disposed near the front portion. One of the protrusion and recess is disposed near the rear portion of the cutting tip, and the cutting insert includes the other of the protrusion and recess disposed near a front portion of said cutting insert. An internal surface of the cutting tip forms a through-hole extending from the front portion to the rear portions of the cutting tip. A rigid connection between the cutting tip and cutting insert is formed by bonding material disposed in the through-hole and said recess. The bonding material is selected from the group consisting of cement, braze, solder, polymer and combinations thereof. An internal surface of the cutting tip forms an unthreaded through-hole extending from the front portion to the rear portions of the cutting tip. An interiorly threaded opening extends from a front into an interior of the cutting insert in alignment with the through-hole, including a fastener threaded into the through-hole and the opening.

Referring now to a second embodiment featuring a carbide insert on chain without bonding, with a straight key, held on with safety link, the cutting links include a base member comprised of sintered particulate metal material. A one-piece cutting insert is comprised of sintered particulate material including carbide. The cutting insert is adapted to be removably disposed on the base member. The cutting insert includes a sharp cutting edge. The base member includes holes for receiving the rivets. A safety lobe is located in proximity to the cutting insert that prevents dislodging of the cutting insert in a direction of travel of the chain. The safety lobe extends from a link that is located upstream of the cutting link. A depth gauge is located upstream of the cutting insert. The safety lobe is disposed between the depth gauge and the cutting insert at all positions of the chain during a cutting operation.

Referring to a third embodiment of the invention, carbide chain has a metal particulate or steel holder, particulate metal insert and carbide tip on chain including the safety link, comprises the plurality of links wherein the cutting links include a base member and a cutting insert comprising sintered particulate metal material. The cutting insert is adapted to be removably disposed on the base member. A cutting tip includes a sharp cutting edge and is comprised of sintered particulate carbide material. The base member includes holes for receiving the rivets. One of the cutting insert and tip includes a protrusion and the other of the cutting insert and cutting tip includes a recess configured to receive the protrusion. The cutting tip is rigidly connected to the cutting insert. One of the cutting insert and base member includes a first projecting seat surface and the other of the cutting insert and base includes a second recessed seat surface configured to receive the first seat surface. A safety lobe is located in proximity to the cutting insert that prevents dislodging of the cutting insert in a direction of travel of the chain. The safety lobe extends from a location upstream of the cutting link. A depth gauge is located upstream of the cutting insert.

Referring to specific features of the third embodiment, the base member comprises sintered particulate metal material. The cutting member is separate from the drive link. The base comprises a body extending up to the rivets. The base member is comprised of steel. The first seat surface is formed in the base member above the body. The cutting insert, cutting tip and base member are formed to provide them with a final net shape, except for the cutting edge which is sharpened. The cutting tip has front and rear portions; the cutting edge is disposed near the front portion, and one of the protrusion and recess is disposed near the rear portion of the cutting tip. The cutting insert includes the other of the protrusion and recess disposed near a front portion of the cutting insert.

Referring to the fourth embodiment a component with high hardness sharp member formed of sintered particulate material, includes a first base member, a second member comprised of sintered particulate material adapted to be disposed on the base member. The second member includes a sharp edge, the particulate material of the second member has a hardness at least as great as a hardness of steel (insert a hardness number of the lowest hardness carbide material). One of the second and first base members includes a protruding first seat surface and the other includes a second recessed seat surface configured to receive the first seat surface. The second member is formed to have a final net shape except for the edge which can be sharpened.

Referring to specific features of the fourth embodiment, the protrusion and recess are bonded together with a material selected from the group consisting of cement, solder, braze, polymer and combinations thereof. The high hardness material includes carbide. The base member is comprised of steel. The second member is comprised of ceramic. The first base member is comprised of metal and the second member is comprised of ceramic, including a ceramic-metal bonding material rigidly connecting the second member to the base member.

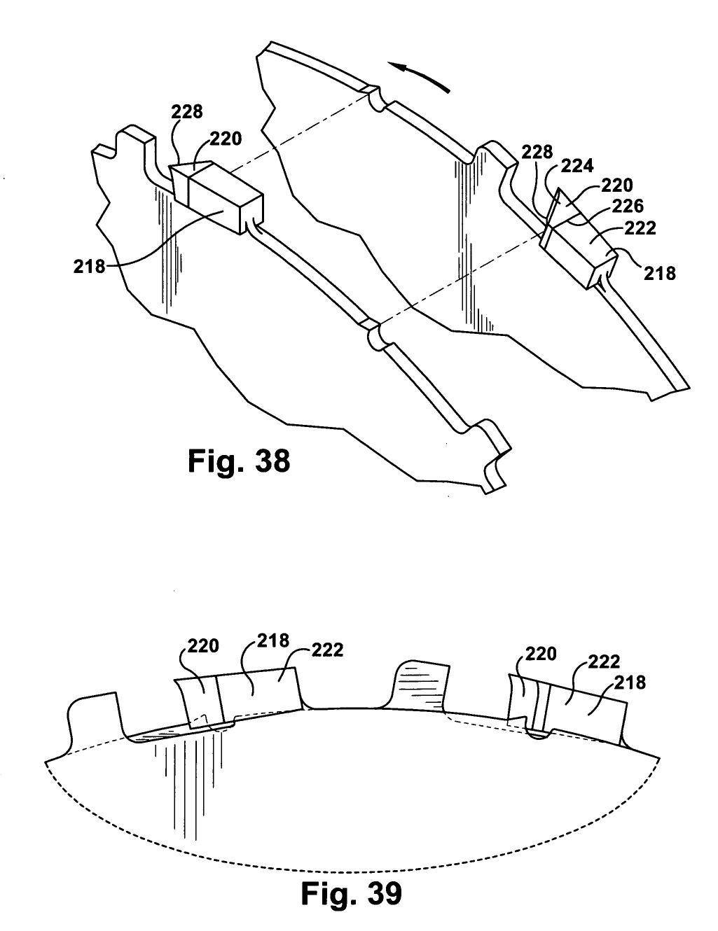

The fifth embodiment features a circular blade (see FIG. 38 with one or two blades and optional safety lobes). The component includes a rigid body in the shape of a circular plate, and a plurality of first members protrude from said plate along a peripheral edge thereof. The second member comprises an insert adapted to be removably disposed on said base and a tip, which are formed of sintered hard particulate material. One of the tip and second insert includes a protrusion and the other of the tip and insert includes a recess adapted to receive the second protrusion. The second member includes a tip formed of carbide and the first seat surface of the base member is steel machined to form the second seat surface. The second member is rigidly connected to the base by a bonding material selected from the group consisting of cement, solder, braze, polymer and combinations thereof.

A sixth embodiment features a one-piece cutting link for saw chain comprised of sintered particulate material. The cutting link includes all features of the cutting link, holder and tooth described above (except no key or keyway) including: rivet holes, a body and a cutting edge disposed above the body. The sintered particulate includes a material selected from the group consisting of: metal, ceramic, composites and combinations thereof.

In a seventh embodiment, the cutting link includes pores that capture lubricant. The cutting link can have a density approximating theoretical density.

An eighth embodiment features a blade including the inventive component including, for example, one of a dado blade, planer blade and bandsaw blade. Referring to FIG. 49, a blade body is represented by C. While this depicts a band-saw tooth it will be appreciated by one of ordinary skill in the art in view of this disclosure that different teeth can be added to the blade making it suitable for various applications beside bandsaws (i.e., on head saws). A left-handed cutter A is shown about to be inserted onto the holder of the blade. A gullet of the blade is represented by B. E shows a right-handed holder of the blade. D shows the tooth insert after it has been inserted onto the right-handed holder of the blade. It will be appreciated that the size and shape and number of the teeth can vary, making the blade suitable as a planer blade, dado blade, bandsaw blade or any other type of blade.

In a ninth embodiment, a device includes the inventive component and is selected from the group consisting of: chain saw, buck saw, rescue saw, automated wood cutting apparatus, circular saw, saw blade, knife, scissors, shears, grass cutter, weed cutter, grass cutting blade, weed cutting blade and combinations thereof.

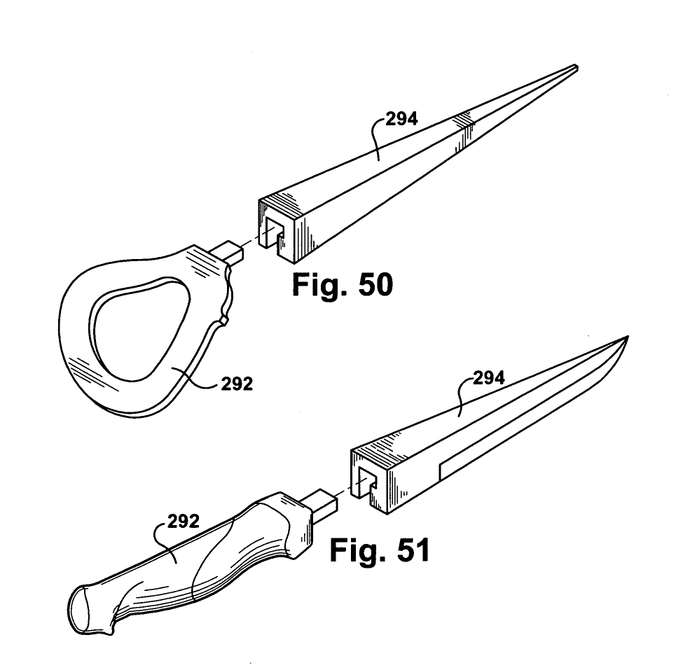

Referring to FIGS. 50 and 51, in a tenth embodiment, the component is in the form of a scissors or a knife, wherein the first base member 292 is a handle and the second member 294 includes a sharp edge on an end of the handle. The second member can include an insert and a tip that are formed of sintered particulate material. The insert is adapted to be removably connected to the first member and one of the tip and insert includes a protrusion and the other of the tip and insert includes a recess adapted to receive the protrusion. The tip includes one of a variety of knife edge sizes and shapes. The tip is comprised of metal having a hardness at least as high as that of steel. The first member includes one of a variety of knife handle shapes and sizes, and handle materials. On the other hand the entire insert may be formed of one piece of sintered particulate material.

Many modifications and variations of the invention will be apparent to those of ordinary skill in the art in light of the foregoing disclosure. Therefore, it is to be understood that, within the scope of the appended claims, the invention can be practiced otherwise than has been specifically shown and described.

What is claimed is:

1. Carbide saw chain comprising:
a plurality of links including drive links, cutting links and tie straps that are pivotally interconnected by rivets; and
wherein said cutting links include a base member comprised of sintered particulate metal material and a cutting member comprised of sintered particulate metal material that includes carbide, said cutting member includes a sharp cutting edge, said base member includes holes for receiving the rivets, and one of said base member and said cutting member includes a first projecting seat surface and the other of said base member and said cutting member includes a second recessed seat surface configured to receive said first seat surface.

2. The carbide saw chain of claim 1 comprising a bonding material between said first and second seat surfaces selected from the group consisting of cement, braze, solder, polymer and combinations thereof.

3. The carbide saw chain of claim 2 wherein said cutting member and said base member are formed by a process that provides said first seat surface and said second seat surface with a final net shape and sharp said cutting edge.

4. The carbide saw chain of claim 3 made by a process selected from the group consisting of powder metal molding, metal injection molding, investment casting and combinations thereof.

5. The carbide saw chain of claim 2 wherein said cutting member and said tie straps are disposed on sides of the chain and the drive links are disposed at a center of the chain.

6. The carbide saw chain of claim 5 wherein said base member includes a body portion extending to a height of said tie straps along the chain and said first seat surface is part of said base member and located above said body portion.

7. The carbide saw chain of claim 6 wherein said first seat surface is a key formed on said base member and said second seat surface is a keyway formed in said cutting member.

8. The carbide saw chain of claim 7 wherein said key and said keyway are untapered.

9. The carbide saw chain of claim 7 wherein said key and said keyway have an inverted L-shape.

10. The carbide saw chain of claim 1 wherein said cutting member is separate from said drive link.

11. The carbide saw chain of claim 1 wherein said cutting member includes a cutting insert comprised of the sintered particulate metal material adapted to be removably disposed on said base member, and a cutting tip comprised of sintered particulate metal material including carbide, said cutting tip including a sharp cutting edge.

12. The carbide saw chain of claim 11 wherein one of said cutting insert and said cutting tip includes a protrusion and the other of said cutting insert and said cutting tip includes a recess configured to receive said protrusion, and said cutting insert and said cutting tip are rigidly connected to each other.

13. The carbide saw chain of claim 12 wherein there is no fastener for preventing said cutting insert from being removed from said base member in a direction of chain travel.

14. The carbide saw chain of claim 12 wherein said rigid connection includes bonding material selected from the group consisting of cement, braze, solder, polymer and combinations thereof.

15. The carbide saw chain of claim 12 wherein said cutting member and said cutting tip are formed by a process that provides them with a final net shape and sharp said cutting edge.

16. The carbide saw chain of claim 15 made by a process selected from the group consisting of powder metal molding, metal injection molding, investment casting and combinations thereof.

17. The carbide saw chain of claim 11 wherein said cutting member is separate from said drive link.

18. The carbide saw chain of claim 12 wherein said base member includes a body portion extending to a height of said tie straps along the chain, further comprising a depth gauge located upstream of said cutting tip.

19. The carbide saw chain of claim 12 wherein said base includes a key and said cutting member includes interior walls that form a keyway configured to receive said key.

20. The carbide saw chain of claim 18 wherein said key and said keyway are untapered.

21. The carbide saw chain of claim 11 wherein said cutting tip has front and rear portions, said cutting edge is disposed near said front portion, one of said protrusion and said recess is disposed near said rear portion of said cutting tip, and said cutting insert includes the other of said protrusion and said recess disposed near a front portion of said cutting insert.

22. The carbide saw chain of claim 20 wherein an internal surface of said cutting tip forms a through-hole extending from said front portion of said cutting tip to said rear portion of said cutting tip and said rigid connection between said cutting tip and said cutting insert is formed by bonding material disposed in said through-hole and said recess.

23. The carbide saw chain of claim 21 wherein said bonding material is selected from the group consisting of cement, braze, solder, polymer and combinations thereof.

24. The carbide saw chain of claim 20 wherein an internal surface of said cutting tip forms an interiorly unthreaded through-hole extending from said front portion of said cutting tip to said rear portion of said cutting tip and an interiorly threaded opening extends from a front portion of said cutting insert into an interior of said cutting insert in alignment with said through-hole, including a fastener threaded into the through-hole and said opening.

25. The carbide saw chain of claim 11 wherein said cutting links include a base member comprised of sintered particulate metal material, a one-piece cutting insert comprised of sintered particulate material including carbide, said cutting insert being adapted to be removably disposed on said base member, said cutting insert including a sharp cutting edge, said base member including holes for receiving the rivets; and a safety lobe located in proximity to said cutting insert that prevents dislodging of said cutting insert in a direction of travel of the chain.

26. The carbide saw chain of claim 25 wherein said safety lobe extends from a link that is located upstream of said cutting link.

27. The carbide saw chain of claim 25 comprising a depth gauge located upstream of said cutting insert, said safety lobe being disposed between said depth gauge and said cutting insert at all positions of the chain during a cutting operation.

28. Carbide saw chain comprising:
a plurality of links including drive links, cutting links and tie straps, which are pivotally interconnected by rivets;
wherein said cutting links include a base member, a cutting insert comprising sintered particulate metal material, said cutting insert being adapted to be removably disposed on said base member, and a cutting tip including a sharp cutting edge and being comprised of sintered particulate carbide material, said base member including holes for receiving the rivets;
wherein one of said cutting insert and said cutting tip includes a protrusion and the other of said cutting insert and said cutting tip includes a recess configured to receive said protrusion, said cutting tip being rigidly connected to said cutting insert;
wherein one of said cutting insert and said base member includes a first projecting seat surface and the other of said cutting insert and said base includes a second recessed seat surface configured to receive said first seat surface;
a safety lobe located in proximity to said cutting insert that prevents dislodging of said cutting insert in a direction of travel of the chain, wherein said safety lobe extends from a link that is located upstream of said cutting link; and
a depth gauge located upstream of said cutting insert.

29. The carbide saw chain of claim 28 wherein said base member comprises sintered particulate metal material.

30. The carbide saw chain of claim 28 wherein said cutting member is separate from said drive link.

31. The carbide saw chain of claim 28 wherein said base member is comprised of steel and includes said first seat surface.

32. The carbide saw chain of claim 28 wherein said cutting insert, said cutting tip and said base member are formed to provide them with a final net shape and said sharp cutting edge.

33. The carbide saw chain of claim 28 wherein said cutting tip has front and rear portions, said cutting edge is disposed near said front portion, and one of said protrusion and said recess is disposed near said rear portion of said cutting tip, and said cutting insert includes the other of said protrusion and said recess disposed near a front portion of said cutting insert.

34. A component with high hardness sharp member formed of sintered particulate material, comprising:
a first base member,
a second member comprised of sintered particulate material adapted to be disposed on said base member, said second member including a sharp edge, the particulate material of said second member having a particle hardness of at least 65 Rockwell C;
wherein one of said second member and said first base member includes a protruding first seat surface and the other of said second member and said first base member includes a second recessed seat surface configured to receive said first seat surface; and
wherein said second member is formed to have a final net shape and said sharp edge.

35. The component of claim 34 wherein said protrusion and said recess are bonded together with a material selected from the group consisting of cement, solder, braze, polymer and combinations thereof.

36. The component of claim 34 wherein said material includes tungsten carbide.

37. The component of claim 34 wherein said material includes STELLITE™ brand material.

38. The component of claim 34 wherein said base member is comprised of steel.

39. The component of claim 34 wherein said second member is comprised of ceramic.

40. The component of claim 34 wherein said first base member is comprised of metal and said second member is comprised of ceramic, including a ceramic-metal bonding material rigidly connecting said second member to said base member.

41. The component of claim 34 comprising a rigid body in the shape of a circular plate, and a plurality of said first members protruding from said plate along a peripheral edge thereof.

42. The component of claim 41 wherein said second member comprises an insert adapted to be removably disposed on said base and a tip that are formed of sintered hard particulate material, one of said tip and said second insert including a protrusion and the other of said tip and said insert including a recess adapted to receive said second protrusion.

43. The component of claim 41 wherein said second member includes a tip formed of carbide and said first seat surface of said base member is steel machined to form said second seat surface, said second member being rigidly connected to said base by a bonding material selected from the group consisting of cement, solder, braze, polymer and combinations thereof.

44. The component of claim 34 in the form of a knife, wherein said first base member is a knife handle and said second member includes a sharp edge on an end of said handle.

45. The component of claim 44 wherein said second member includes an insert and a tip that are formed of sintered particulate material, said insert being adapted to be removably connected to said first member and one of said tip and said insert including a protrusion and the other of said tip and said insert including a recess adapted to receive said protrusion.

46. The component of claim 45 wherein said tip includes one of a variety of knife edge sizes and shapes.

47. The component of claim 45 wherein the particulate material of said tip has a particle hardness of at least 65 Rockwell C.

48. The component of claim 44 wherein said first member includes one of a variety of knife handle shapes and sizes, and handle materials.

49. A blade including the component of claim 34 selected from the group consisting of: dado blade, planer blade and bandsaw blade.

50. A device that includes the component of claim 34, selected from the group consisting of: chain saw, buck saw, rescue saw, automated wood cutting apparatus, circular saw, saw blade, knife, scissors, shears, grass cutter, weed cutter, grass cutting blade, weed cutting blade and combinations thereof.

51. A one-piece cutting link for saw chain comprised of sintered particulate material, wherein said link includes rivet holes, a body and a cutting edge disposed above said body.

52. The cutting link of claim 51 wherein said sintered particulate includes a material selected from the group consisting of: metal, ceramic, composites and combinations thereof.

53. The cutting link of claim 51 wherein a member of said cutting link includes a porosity that captures lubricant.

54. The cutting link of claim 51 wherein said cutting link has a density approximating theoretical density.

55. A method of manufacturing a component comprised of sintered particulate material comprising:
providing a die having a cavity therein;
positioning a removable core pin in said cavity;
positioning a first punch having a recess corresponding to the shape of the core pin, around the core pin in the cavity, at a location short of an end of the core pin;
feeding particulate material into the die around the core pin and onto an internal surface of the first punch;
providing a second punch with a configuration effective to provide a sharp edge to a portion of a part being manufactured;
moving the first punch and the second punch toward each other inside the die cavity by a predetermined distance that is effective to provide the part with suitable density; and
wherein the part has a first sharp edge formed by the second punch and a blind keyway that is formed by the core pin and first punch.

56. The method of claim 55 wherein one of said first punch and said second punch is removed from the die and the other punch moves to eject the component from the die.

57. The method of claim 55 comprising removing a worn core pin from the die and replacing the worn core pin with another core pin.

58. The method of claim 55 comprising removing the second punch from the die after forming the part and raising the first punch to eject the part from the die.

59. The method of claim 55 comprising sintering the parts in a furnace.

60. The method of claim 59 comprising grinding the part to provide a sharp edge.
